(19) United States
(12) Patent Application Publication
(10) Pub. No.: US 2026/0203182 A1
(43) Pub. Date: Jul. 16, 2026

(54) GRAPH-MODELING-BASED LCS COMPONENT POLICY MONITORING SYSTEM

(71) Applicant: Dell Products L.P., Round Rock, TX (US)

(72) Inventors: Douglas Lang Farley, Round Rock, TX (US); Deepak Gaikwad, Natick, MA (US); Rohan Surana, Fremont, CA (US)

(21) Appl. No.: 19/021,413

(22) Filed: Jan. 15, 2025

(51) Int. Cl. G06F 11/34; G06F 11/30; H04L 9/40

(52) U.S. Cl. CPC G06F 11/34; G06F 11/3003; H04L 63/20

(57) ABSTRACT

A graph-modeling-based LCS component policy monitoring system includes resource devices coupled to a resource management system that uses the resource devices to compose an LCS that includes LCS components. The resource management system then generates an LCS component monitoring graph model that includes respective LCS component graph model nodes identifying each LCS component, and a respective LCS component policy graph model node connected to each respective LCS component graph model node via a respective graph model edge and identifying a policy for the LCS component identified by its connected respective LCS component graph model node. The resource management system then provides, for each of the LCS components, a respective agent that monitors that LCS component and determine whether the policy identified by the LCS component policy graph model node connected to the LCS component graph model node identifying that LCS component in the LCS component monitoring graph model is violated.

### BACKGROUND

The present disclosure relates generally to information handling systems, and more particularly to the use of graph modeling to monitor policy compliance of components in Logically Composed Systems (LCSs) provided using information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

While conventional information handling systems such as, for example, server devices and/or other computing devices known in the art have traditionally been provided with particular information handling systems components that configure it to satisfy one or more use cases, new computing paradigms provide for the allocation of resources from information handling systems and/or information handling system components for use in Logically Composed Systems (LCSs) that may be composed as needed to satisfy any computing intent/workload, and then decomposed such that those resources may be utilized in other LCSs. As such, users of the LCSs may be provided with LCSs that meet their current needs for any particular workload they require.

For example, an LCS may be provided using Bare Metal Servers (BMSs), with processing resources and memory resources in the BMS used to provide an Operating System (OS) for the LCS, and with different resources that may be included in the BMS and/or that are connected to the BMS via a network used to provide any desired functionality for the LCS. As such, LCSs may be composed of disaggregated, heterogeneous resources such as firmware, hardware, microvisors, that may be used to perform operations for that LCS, or for “nested” LCSs that may be provided using that LCS. The inventors of the present disclosure have recognized that the relatively low-level, real-time monitoring of such LCSs would be beneficial in understanding and reporting the operations of the resources providing the LCS, enabling the billing of the utilization of any particular resources, forecasting the future use of resources for LCSs, remediation of configuration “drifts” by resources that provide LCSs, and/or providing other monitoring benefits that would be apparent to one of skill in the art in possession of the present disclosure. While conventional virtual machine provisioning systems provide some limited abilities to track virtual machine utilization, those techniques simply do not allow for granular and accurate tracking of each of the components used to provide the LCS, or the utilization of the “nested” LCSs discussed above, particularly when infrastructure layers “beneath” the operating system for the LCS (e.g., firmware and/or hardware) change due to updates, availability, and/or for other reasons.

Furthermore, policies for the provisioning and use of such LCSs and the resources are conventionally enforced by a centralized entity using policies for each LCS component that are often discretely defined for those LCS components and uncorrelated with the other LCS components. Such centralized policy enforcement involves the generation of a static overall policy based on an understanding of individual LCS component behavior and use and without cross-LCS-component correlation, and often fails at some policy enforcement due to the dynamic and correlated use of resources and LCS components to provide the LCS.

Accordingly, it would be desirable to provide an LCS component policy monitoring system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a resource management engine that is configured to: compose, using a plurality of resource devices that are coupled to the processing system, a Logically Composed System (LCS) that includes a plurality of LCS components; generate an LCS component monitoring graph model that includes: respective LCS component graph model nodes identifying each of the plurality of LCS components; and a respective LCS component policy graph model node that is connected to each respective LCS component graph model node via respective graph model edge and that identifies a policy for the LCS component identified by its connected respective LCS component graph model node; provide, for each of the plurality of LCS components, a respective agent that is configured to monitor that LCS component and determine whether the policy identified by the LCS component policy graph model node connected to the LCS component graph model node identifying that LCS component in the LCS component monitoring graph model is violated; and perform, in response to of any of the respective agents provided for any of the plurality of LCS components determining that the policy for that LCS component is violated, at least one policy remediation operation.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a flow chart illustrating an embodiment of a method for monitoring an LCS using graph modeling.

FIG. 8 is a schematic view illustrating an embodiment of a resource management system in the LCS provisioning subsystem of FIG. 3 operating during the method of FIG. 7.

FIG. 9A is a schematic view illustrating an embodiment of the resource management system of FIG. 8 operating during the method of FIG. 7.

FIG. 9B is a schematic view illustrating an embodiment of the resource management system of FIG. 8 operating during the method of FIG. 7.

FIG. 10A is a schematic view illustrating an embodiment of a resource management system in the LCS provisioning subsystem of FIG. 3 operating during the method of FIG. 7.

FIG. 10B is a schematic view illustrating an embodiment of the resource management system of FIG. 10A operating during the method of FIG. 7.

FIG. 11 is a schematic view illustrating an embodiment of the resource management system of FIG. 10A operating during the method of FIG. 7.

FIG. 12A is a schematic view illustrating an embodiment of a resource management system in the LCS provisioning subsystem of FIG. 3 operating during the method of FIG. 7.

FIG. 12B is a schematic view illustrating an embodiment of the resource management system of FIG. 12A operating during the method of FIG. 7.

FIG. 13 is a schematic view illustrating an embodiment of the resource management system of FIG. 12A operating during the method of FIG. 7.

FIG. 14A is a schematic view illustrating an embodiment of a resource management system in the LCS provisioning subsystem of FIG. 3 operating during the method of FIG. 7.

FIG. 14B is a schematic view illustrating an embodiment of the resource management system of FIG. 14A operating during the method of FIG. 7.

FIG. 15 is a schematic view illustrating an embodiment of the resource management system of FIG. 14A operating during the method of FIG. 7.

FIG. 16A is a schematic view illustrating an embodiment of a resource management system in the LCS provisioning subsystem of FIG. 3 operating during the method of FIG. 7.

FIG. 16B is a schematic view illustrating an embodiment of the resource management system of FIG. 16A operating during the method of FIG. 7.

FIG. 16C is a schematic view illustrating an embodiment of the resource management system of FIG. 16A operating during the method of FIG. 7.

FIG. 16D is a schematic view illustrating an embodiment of the resource management system of FIG. 16A operating during the method of FIG. 7.

FIG. 17 is a flow chart illustrating an embodiment of a method for monitoring policies for LCS components using graph modeling.

FIG. 18A is a schematic view illustrating an embodiment of the LCS provisioning subsystem of FIG. 3 provided during the method of FIG. 7.

FIG. 18B is a schematic view illustrating an embodiment of the LCS provisioning subsystem of FIG. 18A operating during the method of FIG. 7.

FIG. 19 is a schematic view illustrating an embodiment of the LCS provisioning subsystem of FIG. 18A operating during the method of FIG. 7.

FIG. 20 is a schematic view illustrating an embodiment of the LCS provisioning subsystem of FIG. 18A operating during the method of FIG. 7.

FIG. 21 is a schematic view illustrating an embodiment of the LCS provisioning subsystem of FIG. 18A operating during the method of FIG. 7.

FIG. 22 is a schematic view illustrating an embodiment of the LCS provisioning subsystem of FIG. 18A operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

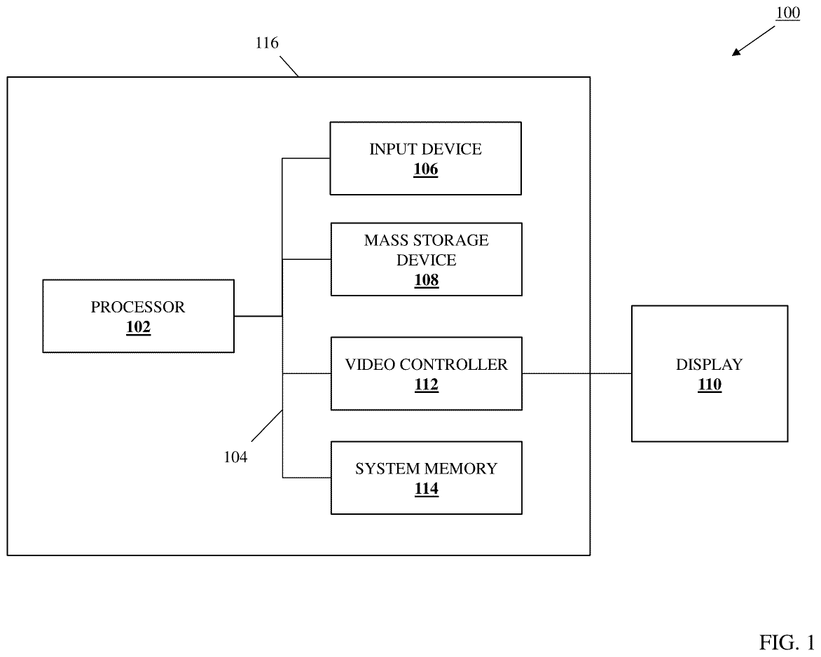

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the graph-modeling-based LCS monitoring systems and methods of the present disclosure may be utilized with Logically Composed Systems (LCSs), which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

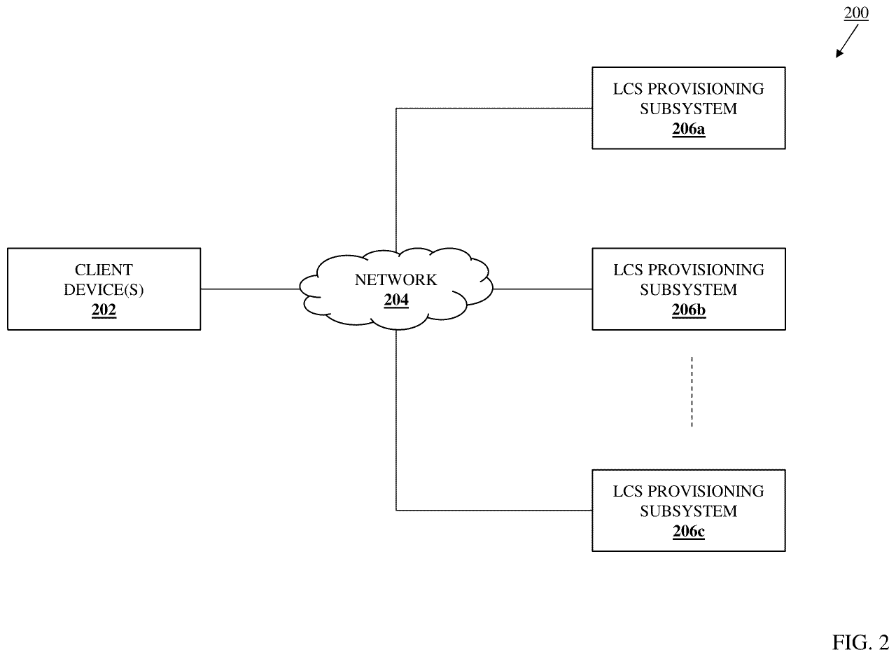

With reference to FIG. 2, an embodiment of a Logically Composed System (LCS) provisioning system 200 is illustrated that may be utilized with the graph-modeling-based LCS monitoring systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

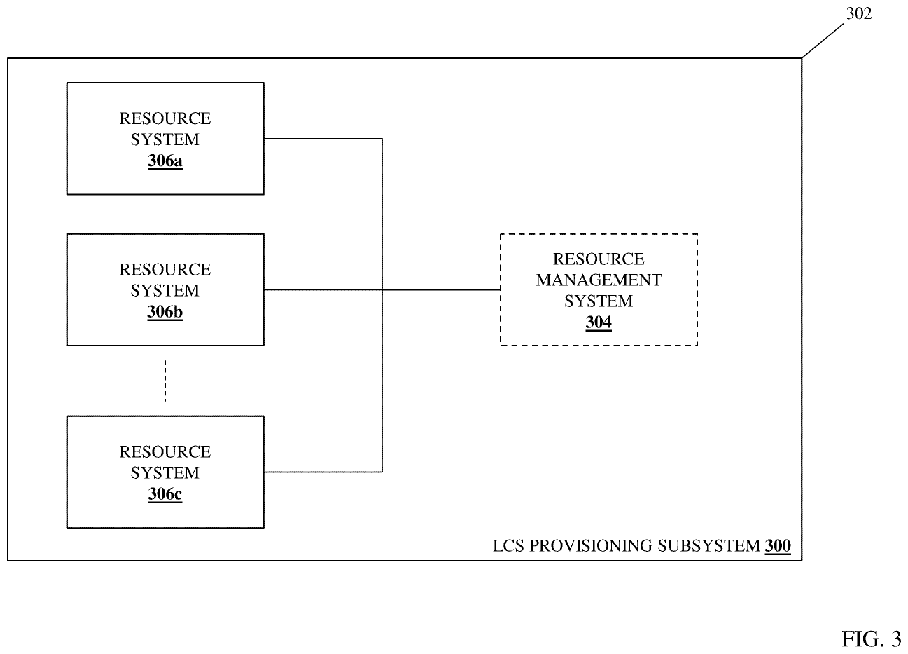

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. The resource management system 304 may include a processing system (not illustrated, but that may be provided by a processor that is similar to the processor 102 discussed above with reference to FIG. 1) and a memory system (not illustrated, but which may be similar to the memory 114 discussed above with reference to FIG. 1) that includes instructions that, when executed by the processing system, cause the processing system to provide a resource management engine that is configured to perform the functionality of the resource management engines, resource management subsystems, and/or resource management systems described below. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other components of that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

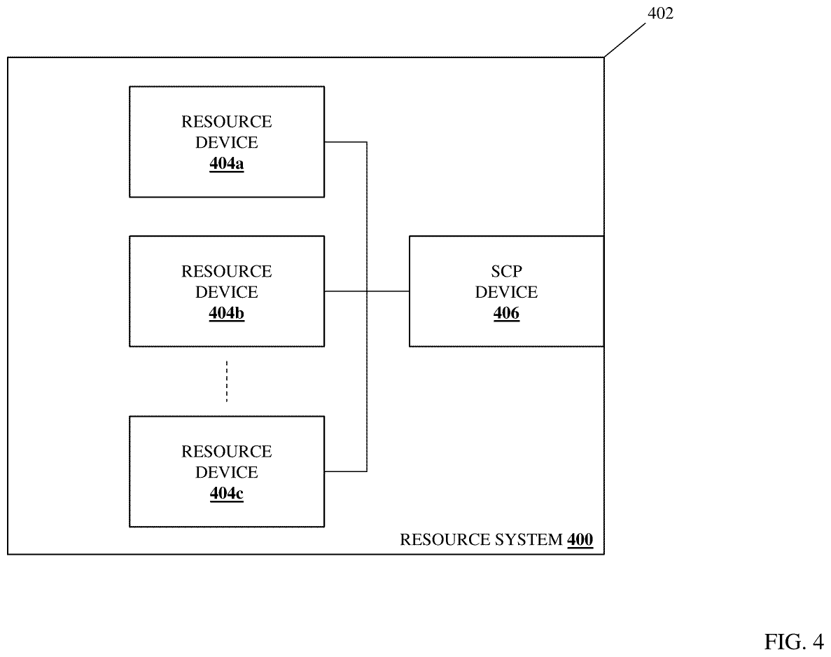

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

As described below, any of the resource devise 404a-404c may include or be coupled to a sensor subsystem that is configured to generate operating information that corresponds to the operation of that resource device, with the SCP device 406 configured to transmit that operating information to the resource management system 304 discussed above with reference to FIG. 3. As such, processing device sensors, networking device sensors, memory device sensors, storage device sensors, and/or other sensors may be included in and/or coupled to the resource devices 404a-404c in order to enable the functionality described below.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

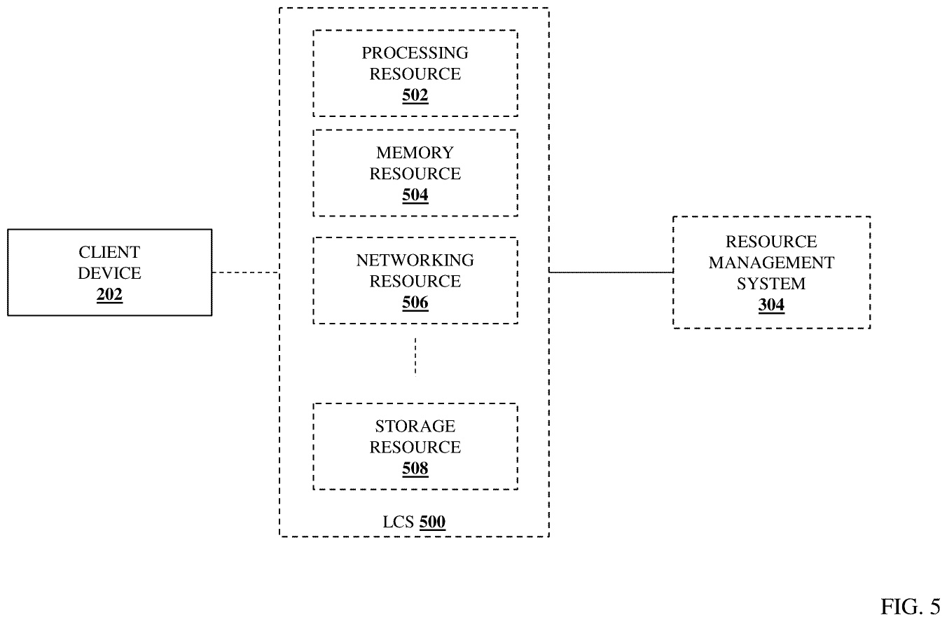

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

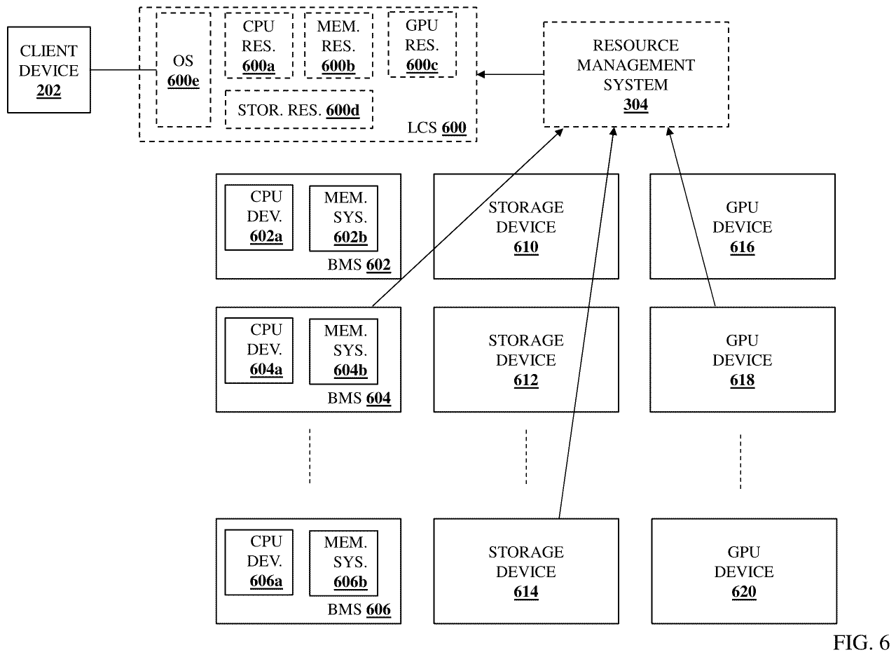

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

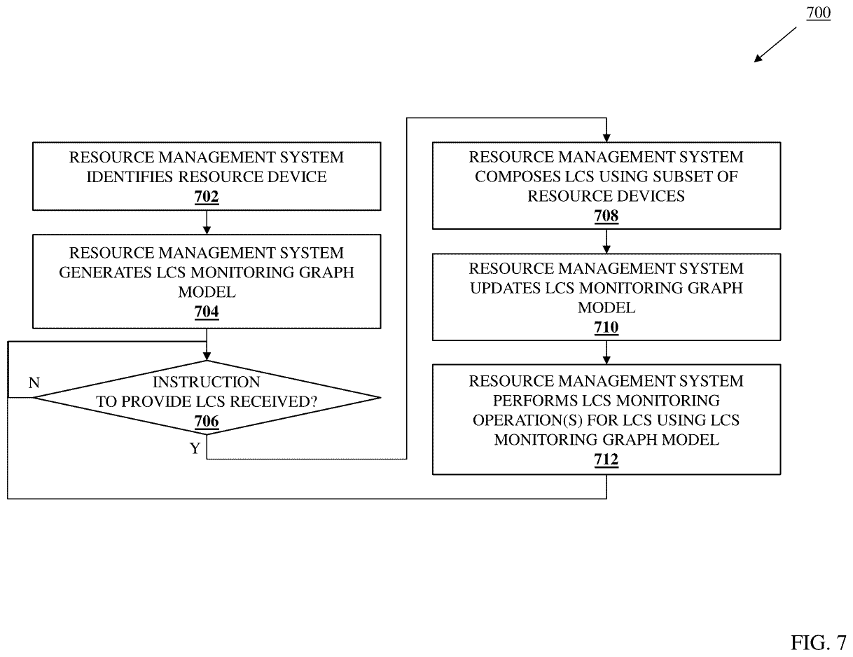

Referring now to FIG. 7, an embodiment of a method 700 for monitoring an LCS using graph modeling is illustrated. As discussed below, the systems and methods of the present disclosure provide a graph model that may be used to monitor the operation of an LCS that has been composed using a plurality of resource devices. The graph-modeling-based LCS monitoring system of the present disclosure may include a resource management system coupled to resource devices. The resource management system identifies the resource devices and generates an LCS monitoring graph model with resource device nodes identifying the resource devices, and respective resource operation nodes connected via edges to those resource device nodes and configured to identify a current operation of their identified resource devices. The resource management system then composes an LCS using a first subset of the resource devices and, in response, updates the LCS monitoring graph model to include an LCS node that identifies the LCS and that is connected to the resource device nodes identifying the first subset of the resource devices. The resource management system then uses information identified from respective resource operation node(s) connected to the resource device nodes identifying the first subset of the resource devices to perform LCS monitoring operation(s) for the LCS. As such, relatively low-level, real-time monitoring of LCSs may be performed to understand and report the operations of the resource devices providing the LCS, enable the billing of the utilization of any particular resource devices, forecast the future use of resource devices for LCSs, remediate configuration “drifts” by resource devices that provide LCSs, and/or provide other monitoring benefits that would be apparent to one of skill in the art in possession of the present disclosure.

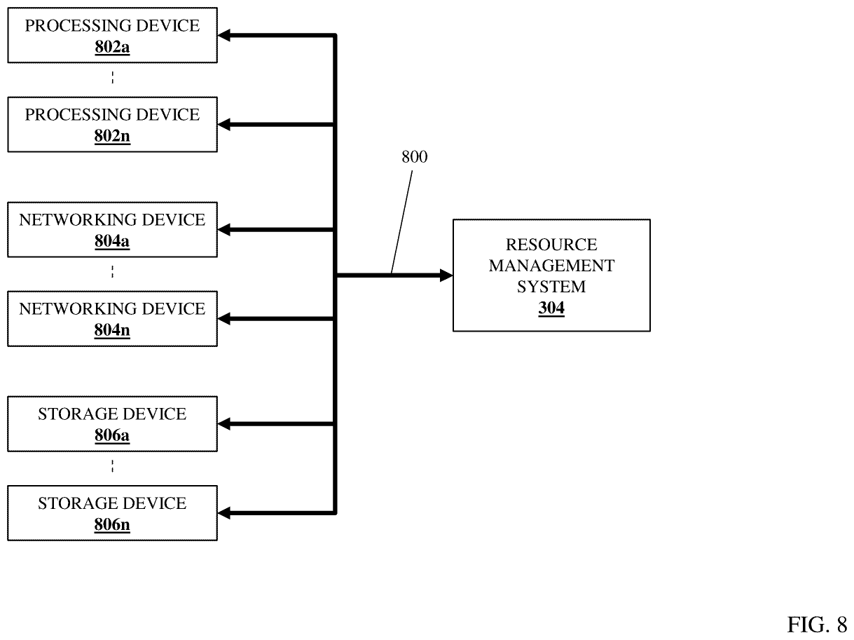

The method 700 begins at block 702 where a resource management system identifies resource devices. In an embodiment, at block 702, the resource management system 304 in the LCS provisioning subsystem 300 discussed above with reference to FIG. 3 may be powered on, booted, reset, rebooted, and/or otherwise initialized and, in response, the resource management system 304 in the LCS provisioning subsystem 300 may perform resource device identification operations that include identifying the resource devices 404a-404c in the resource systems 306a-306c/400 that are coupled to the resource management system 304. With reference to FIG. 8, a specific example of resource device identification operations 800 are illustrated that provide for the identification of a plurality of processing devices 802a-802n (which may be included in the resource devices 404a-404c of the resource systems 306a-306c/400 that are coupled to the resource management system 304), a plurality of networking devices 804a-804n (which may be included in the resource devices 404a-404c of the resource systems 306a-306c/400 that are coupled to the resource management system 304), and a plurality of storage devices 806a-806n (which may be included in the resource devices 404a-404c of the resource systems 306a-306c/400 that are coupled to the resource management system 304). However, while processing devices, networking devices, and storage devices are illustrated and described in the simplified examples provided below, one of skill in the art in possession of the present disclosure will appreciate how any other resource devices may be identified at block 702 while remaining within the scope of the present disclosure as well.

The method 700 then proceeds to block 704 where the resource management system generates an LCS monitoring graph model. In an embodiment, at block 704, the resource management system 304 may perform LCS monitoring graph model generation operations that include generating an LCS monitoring graph model that includes a respective resource device graph model node for each resource device that was identified at block 702, with each respective resource device graph model node connected via a respective edge to a plurality of resource information graph models nodes that are configured to identify information about the resource device identified by that respective resource device graph model node (e.g., the resource capability graph model nodes that identify capabilities of resource devices, the resource operation graph model nodes that identify the operation of resource devices, and the resource policy graph model nodes that identify policies for resource devices in the examples below).

The LCS monitoring graph model may be stored entirely in memory (or other storage) in the resource management system 304. However, in some embodiments, subgraphs of the LCS monitoring graph model may be stored by agents on the resource systems 306a-306c that include the resource devices identified in the LCS monitoring graph model, with those agents tracking changes to the their resource devices to update their subgraphs of the LCS monitoring graph model, enforcing local policies in their resource system, and/or performing other local operations that would be apparent to one of skill in the art in possession of the present disclosure. As such, the resource management system 304 may operate as a “centralized” LCS monitoring system using the LCS monitoring graph model, with agents provided on distributed resource systems updating their subgraphs and synchronizing the subgraphs with the resource management system 304, while performing state management, policy enforcement, and/or other local operations on their resource systems.

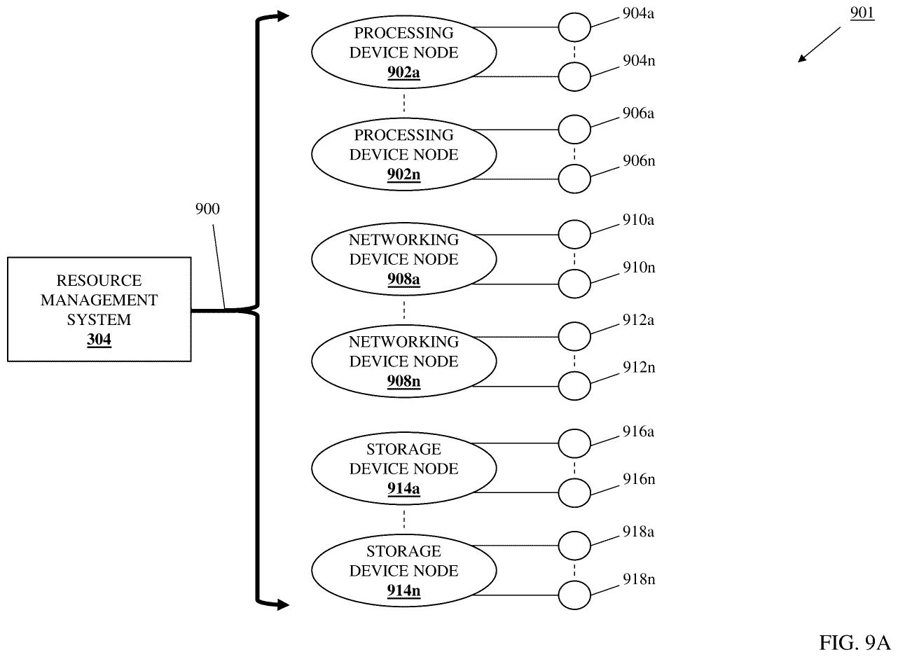

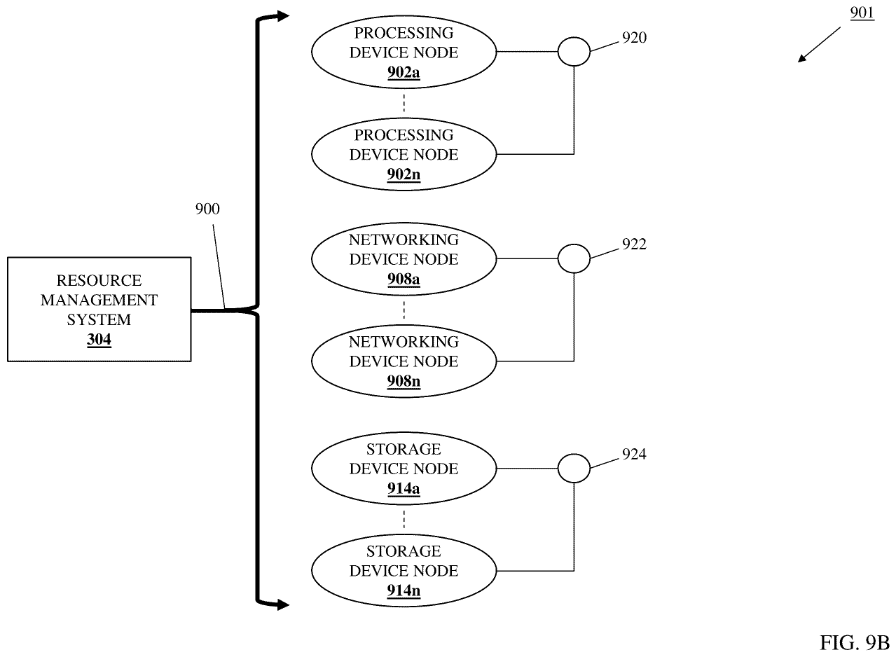

With reference to FIG. 9A, a specific example of LCS monitoring graph model generation operations 900 by the resource management system 304 are illustrated that provide for the generation of an LCS monitoring graph model 901 that includes a respective processing device node 902a-902n for each of the processing devices 802a-802n that were identified at block 702. Furthermore, the LCS monitoring graph model 901 also includes a plurality of processing device information nodes 904a-904n that are each connected to the processing device node 902a by a respective edge, and a plurality of processing device information nodes 906a-906n that are each connected to the processing device node 902n by a respective edge. As described in further detail below, the processing device information nodes 904a-904n may each be configured to identify information about the processing device 802a identified by the processing device node 902a, and the processing device information nodes 906a-906n may each be configured to identify information about the processing device 802n identified by the processing device node 902n.

For example, any of the processing device information nodes may be processing device capability nodes that are configured to identify processing device capability information that describes capabilities of that processing device (e.g., a processing speed of that processing device, a processing power required for that processing device, and/or any other processing device capabilities that would be apparent one of skill in the art in possession of the present disclosure). In another example, any of the processing device information nodes may be processing device operation nodes that are configured to identify processing device operating information that is configured to describe the current operation of that processing device (e.g., a processing bandwidth currently being used by that processing device, a processing power currently being consumed by that processing device, and/or any other processing device operating information that would be apparent one of skill in the art in possession of the present disclosure). In yet another example, any of the processing device information nodes may be processing device policy nodes that are configured to identify processing device policy information that describes policies for using that processing device (e.g., a maximum processing bandwidth that should be used by that processing device, a maximum processing power that should be used by that processing device, and/or any other processing device policies that would be apparent one of skill in the art in possession of the present disclosure).

As such, the processing device information nodes may be configured to identify static processing device information (e.g., the processing device capabilities information discussed above) or dynamic processing device information (e.g., the processing device operating information discussed above that may be retrieved from sensor(s) coupled to that processing device and updated in real-time in the processing device information node(s)), and may be user specific and/or updatable (e.g., the processing device policy information discussed above may be specific to particular users and/or may be updated for users as policies for those users change). As such, the generation of the LCS monitoring graph model 901 may include retrieving any information about a processing device identified by a processing device node and populating that information in the processing device information node(s) connected to that processing device node, linking processing device information node(s) connected to a processing device node to sensor(s) that report information about the processing device identified by that processing device node, and/or any other operations that one of skill in the art in possession of the present disclosure would recognize as enabling the functionality using the LCS monitoring graph models described below. However, while specific examples of processing device information identified by processing device information nodes has been described, one of skill in the art in possession of the present disclosure will appreciate how the processing device information nodes of the present disclosure may identify any information about a processing device while remaining within the scope of the present disclosure.

With continued reference to FIG. 9A, the LCS monitoring graph model 901 also includes a respective networking device node 908a-908n for each of the networking devices 804a-804n that were identified at block 702. Furthermore, the LCS monitoring graph model 901 also includes a plurality of networking device information nodes 910a-910n that are each connected to the networking device node 908a by a respective edge, and a plurality of networking device information nodes 912a-912n that are each connected to the networking device node 908n by a respective edge. As described in further detail below, the processing device information nodes 910a-910n may each be configured to identify information about the networking device 804a identified by the networking device node 908a, and the networking device information nodes 912a-912n may each be configured to identify information about the networking device 804n identified by the networking device node 908n.

For example, any of the networking device information nodes may be networking device capability nodes that are configured to identify networking device capability information that describes capabilities of that networking device (e.g., a networking speed of that networking device, a networking power required for that networking device, and/or any other networking device capabilities that would be apparent one of skill in the art in possession of the present disclosure). In another example, any of the networking device information nodes may be networking device operation nodes that are configured to identify networking device operating information that is configured to describe the current operation of that networking device (e.g., a networking bandwidth currently being used by that networking device, a networking power currently being consumed by that networking device, and/or any other networking device operating information that would be apparent one of skill in the art in possession of the present disclosure). In yet another example, any of the networking device information nodes may be networking device policy nodes that are configured to identify networking device policy information that describes policies for using that networking device (e.g., a maximum networking bandwidth that should be used by that networking device, a maximum networking power that should be used by that networking device, and/or any other networking device policies that would be apparent one of skill in the art in possession of the present disclosure).

As such, the networking device information nodes may be configured to identify static networking device information (e.g., the networking device capabilities information discussed above) or dynamic networking device information (e.g., the networking device operating information discussed above that may be retrieved from sensor(s) coupled to that networking device and updated in real-time in the networking device information node(s)), and may be user specific and/or updatable (e.g., the networking device policy information discussed above may be specific to particular users and/or may be updated for users as policies for those users change). As such, the generation of the LCS monitoring graph model 901 may include retrieving any information about a networking device identified by a networking device node and populating that information in the networking device information node(s) connected to that networking device node, linking networking device information node(s) connected to a networking device node to sensor(s) that report information about the networking device identified by that networking device node, and/or any other operations that one of skill in the art in possession of the present disclosure would recognize as enabling the functionality using the LCS monitoring graph models described below. However, while specific examples of networking device information identified by networking device information nodes has been described, one of skill in the art in possession of the present disclosure will appreciate how the networking device information nodes of the present disclosure may identify any information about a networking device while remaining within the scope of the present disclosure.

With continued reference to FIG. 9A, the LCS monitoring graph model 901 also includes a respective storage device node 914a-914n for each of the networking devices 806a-806n that were identified at block 702. Furthermore, the LCS monitoring graph model 901 also includes a plurality of storage device information nodes 916a-916n that are each connected to the storage device node 914a by a respective edge, and a plurality of storage device information nodes 918a-918n that are each connected to the storage device node 914n by a respective edge. As described in further detail below, the storage device information nodes 916a-916n may each be configured to identify information about the storage device 806a identified by the storage device node 914a, and the storage device information nodes 918a-918n may each be configured to identify information about the storage device 806n identified by the storage device node 914n.

For example, any of the storage device information nodes may be storage device capability nodes that are configured to identify storage device capability information that describes capabilities of that storage device (e.g., a storage speed of that storage device, a storage power required for that storage device, and/or any other storage device capabilities that would be apparent one of skill in the art in possession of the present disclosure). In another example, any of the storage device information nodes may be storage device operation nodes that are configured to identify storage device operating information that is configured to describe the current operation of that storage device (e.g., a storage bandwidth currently being used by that storage device, a storage power currently being consumed by that storage device, and/or any other storage device operating information that would be apparent one of skill in the art in possession of the present disclosure). In yet another example, any of the storage device information nodes may be storage device policy nodes that are configured to identify storage device policy information that describes policies for using that storage device (e.g., a maximum storage bandwidth that should be used by that storage device, a maximum storage power that should be used by that storage device, and/or any other storage device policies that would be apparent one of skill in the art in possession of the present disclosure).

As such, the storage device information nodes may be configured to identify static storage device information (e.g., the storage device capabilities information discussed above) or dynamic storage device information (e.g., the storage device operating information discussed above that may be retrieved from sensor(s) coupled to that storage device and updated in real-time in the storage device information node(s)), and may be user specific and/or updatable (e.g., the storage device policy information discussed above may be specific to particular users and/or may be updated for users as policies for those users change). As such, the generation of the LCS monitoring graph model 901 may include retrieving any information about a storage device identified by a storage device node and populating that information in the storage device information node(s) connected to that storage device node, linking storage device information node(s) connected to a storage device node to sensor(s) that report information about the storage device identified by that storage device node, and/or any other operations that one of skill in the art in possession of the present disclosure would recognize as enabling the functionality using the LCS monitoring graph models described below. However, while specific examples of storage device information identified by storage device information nodes has been described, one of skill in the art in possession of the present disclosure will appreciate how the storage device information nodes of the present disclosure may identify any information about a storage device while remaining within the scope of the present disclosure.

While each of the processing device nodes 902a-902n, the networking device nodes 908a-908n, and the storage device nodes 914a-914n are illustrated as including “dedicated” processing device information nodes, networking device information nodes, and storage device information nodes, respectively, one of skill in the art in possession of the present disclosure will appreciate how resource device graph model nodes may share resource information graph model nodes while remaining within the scope of the present disclosure as well. For example, as illustrated in FIG. 9B, the LCS monitoring graph model 901 may include a processing device information node 920 that may be connected to any subset of the processing device nodes 902a-902n by respective edges, a networking device information node 922 that may be connected to any subset of the networking device nodes 908a-908n by respective edges, and a storage device information node 924 that may be connected to any of the storage device nodes 914a-914n by respective edges.

As will be appreciated by one of skill in the art in possession of the present disclosure, the “shared” processing device information node 920 may be configured to identify information that is common to the processing device 802a-802n identified by the processing device nodes 902a-902n that are connected to the processing device information node 920 (e.g., the processing device information node 920 may identify “x86” processing devices). Similarly, the “shared” networking device information node 922 may be configured to identify information that is common to the networking device 804a-804n identified by the networking device nodes 908a-908n that are connected to the networking device information node 922 (e.g., the networking device information node 922 may identify networking devices with a minimum bandwidth). Similarly, the “shared” storage device information node 924 may be configured to identify information that is common to the storage device 806a-806n identified by the storage device nodes 914a-914n that are connected to the storage device information node 924 (e.g., the storage device information node 924 may identify storage devices with a minimum storage capacity).

As will be appreciated by one of skill in the art in possession of the present disclosure, the resource management system 304 may be configured to monitor is connected resource devices to identify when resource devices are disconnected from (or otherwise unavailable to) the resource management system 304, or when “new” resource devices are connected to (or become available to) the resource management 304, and in response, update the LCS monitoring graph model 901 to remove resource device graph model nodes (and their resource information graph model nodes) for the disconnected resource devices, and add resource device graph model nodes (and corresponding resource information graph model nodes) for connected resource devices. As such, the LCS monitoring graph model 901 may be provided by a dynamically updated “digital twin” of the LCS provisioning subsystem 300 that digitally identifies the connective state of the resource management system 304 with respect to its connected resource devices. Furthermore, while a specific LCS monitoring graph model has been illustrated and described, one of skill in the art in possession of the present disclosure will appreciate how LCS monitoring graph models provided according to the teachings of the present disclosure may include a variety of configurations for digitally modeling the resource devices that are available to a resource management system for providing an LCS as described in further detail below.

The method 700 then proceeds to decision block 706 where the method 700 proceeds depending on whether an instruction to provide an LCS is received. As discussed above, following its initialization and discovery of resource devices, the resource management system 304 may receive an instruction to provide an LCS that is generated and provided to the resource management system 304 in response to a user expressing a workload intent to the LCS provisioning subsystem 300. As such, at decision block 706, the method 700 will proceed depending on whether such an instruction is received by the resource management system 304. If, at decision block 706, no instruction to provide an LCS is received, the method 700 returns to decision block 706. As such, the method 700 may loop such that that resource management system 304 monitors for an instruction to provide an LCS, and as discussed above the resource management system 304 may discover “new” resource devices and add them to the LCS monitoring graph model 901 when those resource devices are coupled to the resource management system 304, remove “old” resource devices from the LCS monitoring graph model 901 when those resource devices are decoupled or otherwise become unavailable to the resource management system 304, and/or perform other LCS monitoring graph model operations while looping through decision block 706.

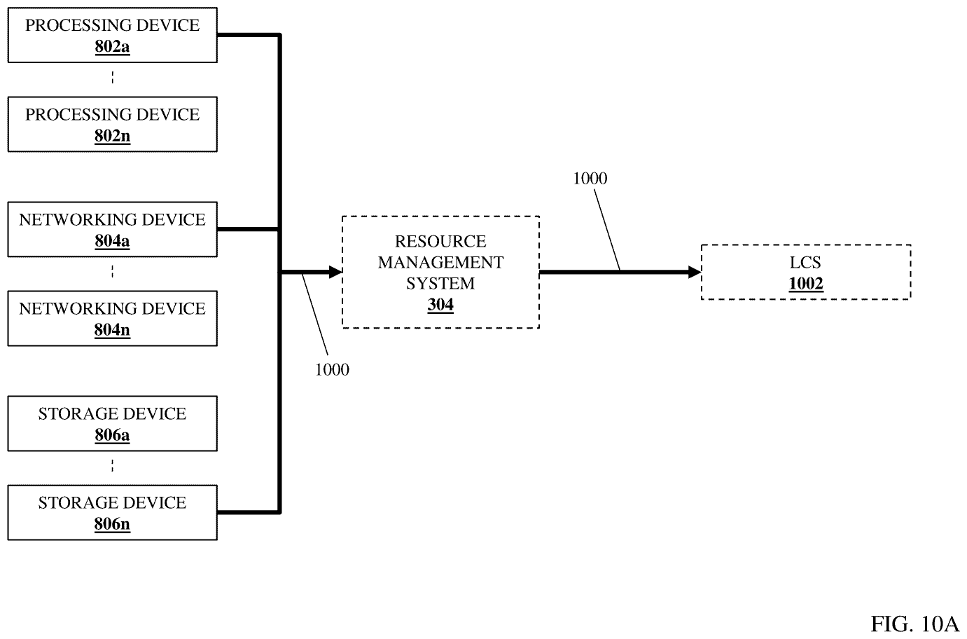

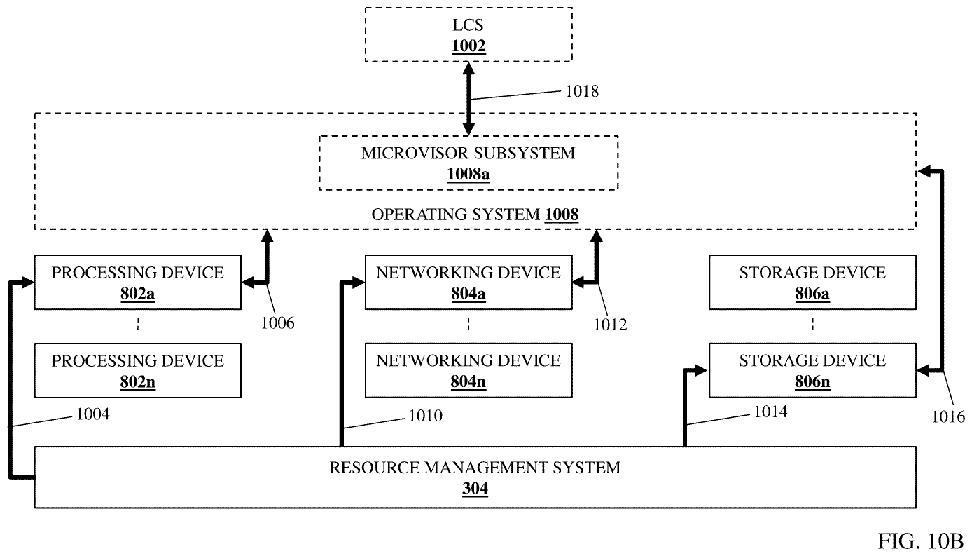

If, at decision block 706, an instruction to provide an LCS is received, the method 700 proceeds to block 708 where the resource management system composes an LCS using a subset of the resource devices. In an embodiment, at decision block 706, the resource management system 304 may receive an instruction to provide an LCS that may have been generated based on a workload intent expressed by a user as described above and, in response, may compose an LCS using its available resource devices to satisfy that workload intent. For example, with reference to FIG. 10A, in response to receiving an instruction to provide an LCS, the resource management system 304 may perform LCS composition operations 1000 that include composing an LCS 1002 using the processing device 802a, the networking device 804a, and the storage device 806n.

For example, as illustrated in FIG. 10B, the LCS composition operations 1000 performed by the resource management system 304 may include processing device configuration operations 1004 that configure the processing device 802a to perform processing operations 1006 to provide the LCS 1002 (e.g., in cooperation with an operating system 1008 including a microvisor subsystem 1008a that is provided using any of the processing devices 802a-802n (and corresponding memory devices, not illustrated) available to the resource management system 304 in, for example, one of the BMSs discussed above), networking device configuration operations 1010 that configure the networking device 804a to perform networking operations 1012 to provide networking for the LCS 1002 (e.g., by transmitting data to and from the LCS 1002), and storage device configuration operations 1014 that configure the storage device 806n to perform storage operations 1016 to provide storage for the LCS 1002 (e.g., by storing data utilized by\the LCS 1002). The microvisor subsystem 1008a in the operating system 1008 may then operate using the processing device 802a, the networking device 804a, and the storage device 806n to perform LCS provisioning operations 1018 to provide the LCS 1002. However, while the composition of an LCS using the simplified example of resource devices provided by the processing devices 802a-802n, networking devices 804a-804n, and storage devices 806a-806n is provided herein, one of skill in the art in possession of the present disclosure will appreciate how LCSs may be composed using a variety of resource devices while remaining within the scope of the present disclosure as well.

The method 700 then proceeds to block 710 where the resource management system updates the LCS monitoring graph model. In an embodiment, at block 710 and in response to composing the LCS at block 708, the resource management system 304 may perform LCS monitoring graph model update operations that include updating the LCS monitoring graph model generated at block 704 to include an LCS graph model node for the LCS that was composed at block 708, with the LCS graph model node connected via a respective edge to a subset of the resource device graph models nodes that identify the resource devices that are being used to provide that LCS, and connected via a respective edge to a plurality of LCS information graph model nodes that are configured to identify information about the LCS identified by the LCS graph model node (e.g., LCS capability graph model nodes that identify capabilities of LCSs, LCS operation graph model nodes that identify the operation of LCSs, and LCS policy graph model nodes that identify policies for LCSs in the examples below).

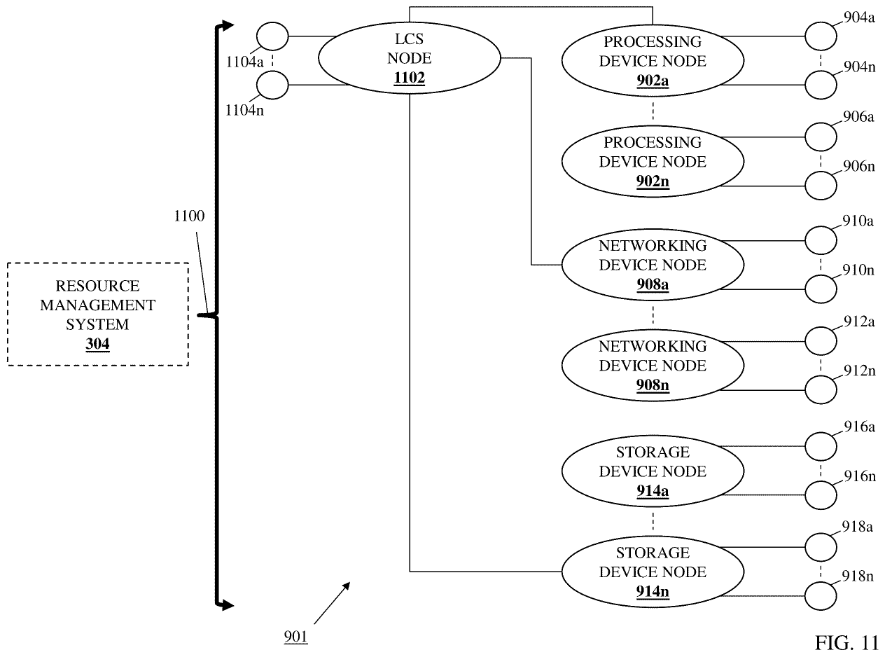

For example, with reference to FIG. 11, a specific example of LCS monitoring graph model update operations 1100 by the resource management system 304 are illustrated that provide for the updating of the LCS monitoring graph model 901 to include an LCS node 1102 for the LCS 1002 that was composed at block 708. Furthermore, the LCS monitoring graph model 901 is also updated to provide an edge that connects the LCS node 1102 to the processing device node 902a that identifies the processing device 802a that was used to compose the LCS 1002, an edge that connects the LCS node 1102 to the networking device node 908a that identifies the networking device 804a that was used to compose the LCS 1002, and an edge that connects the LCS node 1102 to the storage device node 914n that identifies the storage device 806n that was used to compose the LCS 1002. Further still, the LCS monitoring graph model 901 is also updated to include a plurality of LCS information nodes 1104a-1104n that are each connected to the LCS node 1102 by a respective edge. As described in further detail below, the LCS information nodes 1104a-1104n may each be configured to identify information about the LCS 1002 identified by the LCS node 1102.

For example, any of the LCS information nodes 1104a-1104n may be LCS capability nodes that are configured to identify LCS capability information that describes capabilities of the LCS 1002 (e.g., system capabilities such as database provisioning capabilities, vector database provisioning capabilities, static web server provisioning capabilities, object storage provisioning capabilities, file hierarchical storage provisioning capabilities, and data movement (e.g., Direct Memory Access (DMA) provisioning capabilities; Artificial Intelligence (AI) capabilities such as Retrieval-Augmented Generation (RAG) Model (“XYZ”) provisioning capabilities, and Large Language Model (LLM) implementation provisioning capabilities; security capabilities such as OpenID Connect (OIDC) Authentication Connector provisioning capabilities, OpenTelemetry (OTEL) Trace Collector provisioning capabilities, Certificate Authority (CA) Verification provisioning capabilities, and Data Inspection Proxy provisioning capabilities; Quality of Service (QoS) provisioning capabilities that provide performance, scalability, availability, and serviceability needs for LCSs, and/or any other LCS capabilities that would be apparent one of skill in the art in possession of the present disclosure).

In another example, any of the LCS information nodes 1104a-1104n may be LCS operation nodes that are configured to identify LCS operating information that is configured to describe the current operation of the LCS 1002 (e.g., currently present and/or enabled capabilities for the LCS 1002, capability dependencies (e.g., name and version) required for the LCS 1002, configuration metadata for the LCS 1002, an Internet Protocol (IP) address for the LCS 1002, a name of the LCS 1002, a cryptographic or otherwise unique identification for the LCS 1002, credentials and account information for the LCS 1002, tenant owner information for the LCS 1002, LCS runtime policy information for the LCS 1002, and/or any other LCS operating information that would be apparent one of skill in the art in possession of the present disclosure).

In yet another example, any of the LCS information nodes 1104a-1104n may be LCS policy nodes that are configured to identify LCS policy information that describes policies for using the LCS 1002 (e.g., Central Processing Unit (CPU) burst policies (e.g., to allow CPU operation above a threshold for some time period after which a limit will be enforced), networking burst policies (e.g., to allow link utilization above a threshold for some time period after which a limit will be enforced), limited radix policies (e.g., capping the number of Transmission Control Protocol (TCP) connections allowed at the same time), data scrubbing policies (e.g., defining a maximum time period that persistent data will remain stored before it is expunged), access policies (e.g., defining access to IP address as only being allowed via a proxy address outside of a subset), hardware policies (e.g., allowing an Advanced Vector eXtension (AVX) instruction vector multiply to use a hardware offload rather than software interpolation), administrator policies (e.g., to only allow access to resource system objects or telemetry data to users having a system/infrastructure administrator role, or only allow create/delete operations on resource state tag objects for owners of a corresponding resource), and/or any other LCS policies that would be apparent one of skill in the art in possession of the present disclosure).

As such, the LCS information nodes 1104a-1104n may be configured to identify static LCS information (e.g., the LCS capabilities information discussed above) or dynamic LCS information (e.g., the LCS operating information discussed above that may be retrieved from sensor(s) coupled to the processing device 802a, networking device 804a, and storage device 806n that are being used to provide the LCS 1002 and that may be updated in real-time in the LCS information node(s) 1104a-1104n), and may be user specific and/or updatable (e.g., the LCS policy information discussed above may be specific to particular users and/or may be updated for users as policies for those users change). As such, the updating of the LCS monitoring graph model 901 may include retrieving any information about the LCS 1002 identified by the LCS node 1102 and populating that information in the LCS information node(s) 1104a-1104n connected to the LCS node 1102, linking the LCS information node(s) 1104a-1104n connected to the LCS node 1102 to sensor(s) that report information about the resource devices that are being used to provide the LCS 1002 identified by that LCS node 1102, and/or any other operations that one of skill in the art in possession of the present disclosure would recognize as enabling the functionality using the LCS monitoring graph models described below. However, while specific examples of LCS information identified by LCS information nodes has been described, one of skill in the art in possession of the present disclosure will appreciate how the LCS information nodes of the present disclosure may identify any information about an LCS while remaining within the scope of the present disclosure.

As will be appreciated by one of skill in the art in possession of the present disclosure, the resource devices used to provide the LCS 1002 may change through the provisioning of the LCS 1002, and the resource management system 304 may be configured to modify the LCS monitoring graph model 901 to remove resource device graph model nodes for resource devices that are unavailable for providing the LCS 1002, add “new” resource device graph model nodes for “new” resource devices that are then used to provide the LCS 1002, connect those “new” resource device graph model nodes to the LCS node 1102, and provide the resource information graph model nodes for the “new” resource device graph model nodes similarly as described above. As such, the LCS monitoring graph model 901 may dynamically change to reflect the current provisioning of the LCS 1002.

The method 700 then proceeds to block 712 where the resource management system performs one or more LCS monitoring operations for the LCS using the LCS monitoring graph model. As discussed in further detail below, in an embodiment of block 712 and after updating the LCS monitoring graph model 901 at block 710 for the LCS 1002 composed at block 708, the resource management system 304 may perform any of a variety of LCS monitoring operations for the LCS 1002 using the LCS monitoring graph model 901. The specific example provided herein for the method 700 describes an embodiment in which the resource management system 304 composes and monitors a plurality of LCSs, and thus the composing of each of those LCSs is described below before the discussion of the use of the LCS monitoring graph model 901 in the monitoring of those LCSs at block 712. However, while a discussion of the monitoring of a plurality of LCSs by the resource management system 304 is described below, one of skill in the art in possession of the present disclosure will appreciate how a single LCS may be monitored by the resource management system 304 similarly as described below while remaining within the scope of the present disclosure as well.

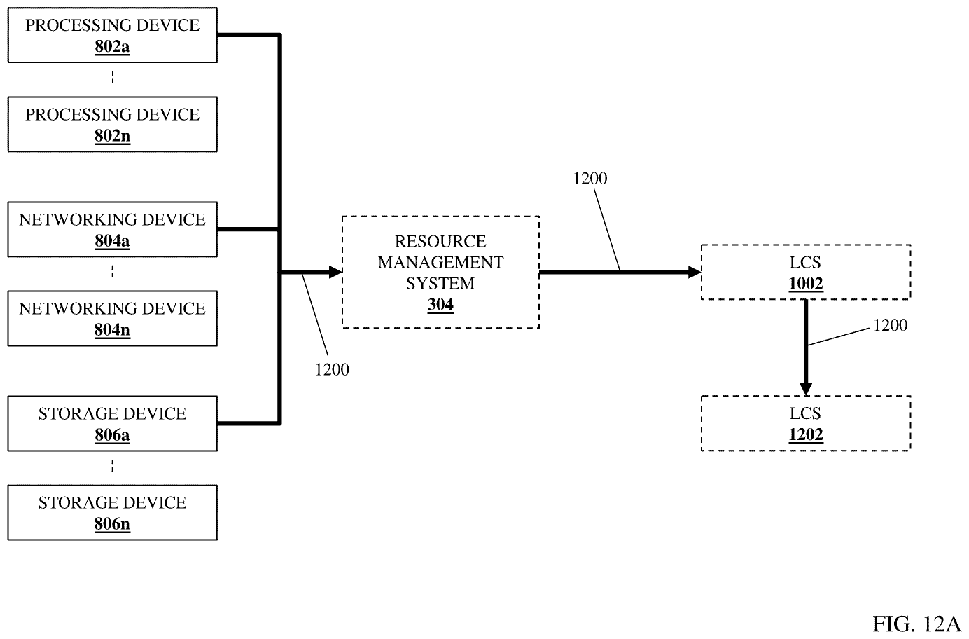

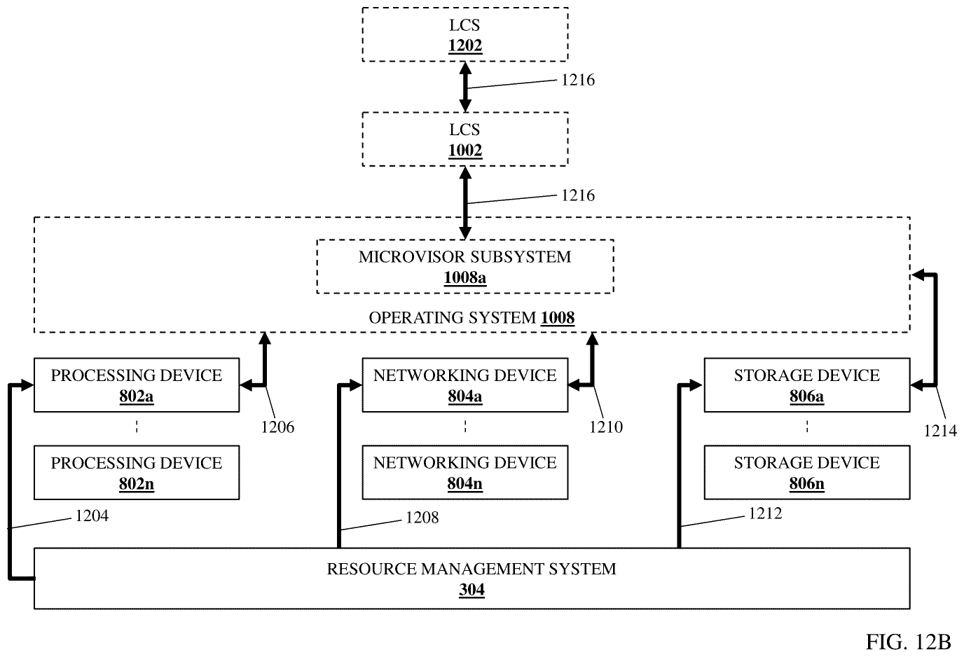

As such, following the composing of the LCS 1002 at block 708 and the updating of the LCS monitoring graph model 901 at block 710, the LCS 1002 may be monitored using the LCS monitoring graph model 901 and the method may return to decision block 706 to determine whether another instruction is received to provide another LCS similarly as described above. With reference to FIG. 12A and in response to receiving an instruction to provide an LCS during a subsequent iteration of decision block 706, the resource management system 304 may perform LCS composition operations 1200 that include composing an LCS 1202 using the processing device 802a, the networking device 804a, and the storage device 806a. As will be appreciated by one of skill in the art in possession of the present disclosure, the embodiment illustrated in FIG. 12A provides an example of the composition of a “nested” LCS 1202 using the same processing device 802a as the LCS 1002 (e.g., a first subset of core(s) in the processing device 802a may be used to provide the LCS 1002, and a second subset of core(s) in the processing device 802a may be used to provide the LCS 1202). However, while a specific example of a “nested” LCS is illustrated and described, one of skill in the art in possession of the present disclosure will appreciate how “nested” LCSs may be provided using a variety of techniques and/or in a variety of manners that will fall within the scope of the present disclosure as well.

For example, as illustrated in FIG. 12B, the LCS composition operations 1200 performed by the resource management system 304 may include processing device configuration operations 1204 that configure the processing device 802a to perform processing operations 1206 to provide the LCS 1202 (e.g., in cooperation with the operating system 1008 including the microvisor subsystem 1008a that is provided using any of the processing devices 802a-802n (and corresponding memory devices, not illustrated) available to the resource management system 304 in, for example, one of the BMSs discussed above), networking device configuration operations 1208 that configure the networking device 804a to perform networking operations 1210 to provide networking for the LCS 1202 (e.g., by transmitting data to and from the LCS 1202), and storage device configuration operations 1012 that configure the storage device 806a to perform storage operations 1214 to provide storage for the LCS 1202 (e.g., by storing data utilized by the LCS 1202). The microvisor subsystem 1008a in the operating system 1008 may then operate using the processing device 802a, the networking device 804a, and the storage device 806a to perform LCS provisioning operations 1216 to provide the LCS 1202. However, while the composition of an LCS using the simplified example of resource devices provided by the processing devices 802a-802n, networking devices 804a-804n, and storage devices 806a-806n is provided herein, one of skill in the art in possession of the present disclosure will appreciate how LCSs may be composed using a variety of resource devices while remaining within the scope of the present disclosure as well.

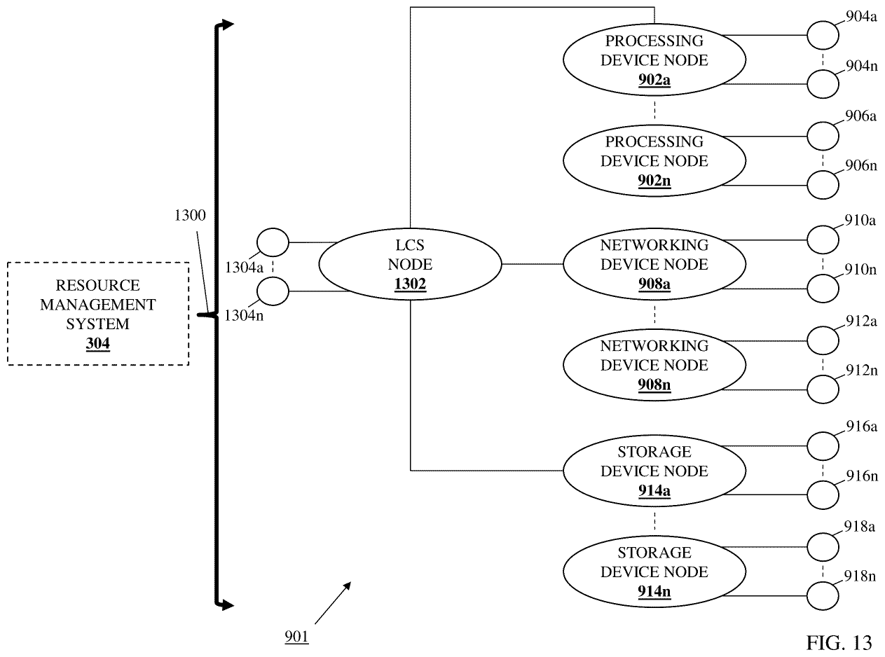

The method 700 then proceeds to a subsequent iteration of block 710 where the resource management system updates the LCS monitoring graph model. For example, with reference to FIG. 13, a specific example of LCS monitoring graph model update operations 1300 by the resource management system 304 are illustrated that provide for the updating of the LCS monitoring graph model 901 to include an LCS node 1302 for the LCS 1202 that was composed at the subsequent iteration of block 708. Furthermore, the LCS monitoring graph model 901 is also updated to provide an edge that connects the LCS node 1302 to the processing device node 902a that identifies the processing device 802a that was used to compose the LCS 1202, an edge that connects the LCS node 1302 to the networking device node 908a that identifies the networking device 804a that was used to compose the LCS 1202, and an edge that connects the LCS node 1302 to the storage device node 914a that identifies the storage device 806a that was used to compose the LCS 1202. Further still, the LCS monitoring graph model 901 is also updated to include a plurality of LCS information nodes 1304a-1304n that are each connected to the LCS node 1302 by a respective edge. As described in further detail below, the LCS information nodes 1304a-1304n may each be configured to identify information about the LCS 1202 identified by the LCS node 1302.

For example, any of the LCS information nodes 1304a-1304n may be LCS capability nodes that are configured to identify LCS capability information that describes capabilities of the LCS 1202 (e.g., system capabilities such as database provisioning capabilities, vector database provisioning capabilities, static web server provisioning capabilities, object storage provisioning capabilities, file hierarchical storage provisioning capabilities, and data movement (e.g., Direct Memory Access (DMA) provisioning capabilities; Artificial Intelligence (AI) capabilities such as Retrieval-Augmented Generation (RAG) Model (“XYZ”) provisioning capabilities, and Large Language Model (LLM) implementation provisioning capabilities; security capabilities such as OpenID Connect (OIDC) Authentication Connector provisioning capabilities, OpenTelemetry (OTEL) Trace Collector provisioning capabilities, Certificate Authority (CA) Verification provisioning capabilities, and Data Inspection Proxy provisioning capabilities; Quality of Service (QoS) provisioning capabilities that provide performance, scalability, availability, and serviceability needs for LCSs, and/or any other LCS capabilities that would be apparent one of skill in the art in possession of the present disclosure).

In another example, any of the LCS information nodes 1304a-1304n may be LCS operation nodes that are configured to identify LCS operating information that is configured to describe the current operation of the LCS 1202 (e.g., currently present and/or enabled capabilities for the LCS 1202, capability dependencies (e.g., name and version) required for the LCS 1202, configuration metadata for the LCS 1202, an Internet Protocol (IP) address for the LCS 1202, a name of the LCS 1202, a cryptographic or otherwise unique identification for the LCS 1202, credentials and account information for the LCS 1202, tenant owner information for the LCS 1202, LCS runtime policy information for the LCS 1202, and/or any other LCS operating information that would be apparent one of skill in the art in possession of the present disclosure).

In yet another example, any of the LCS information nodes 1304a-1304n may be LCS policy nodes that are configured to identify LCS policy information that describes policies for using the LCS 1202 (e.g., CPU burst policies (e.g., to allow CPU operation above a threshold for some time period after which a limit will be enforced), networking burst policies (e.g., to allow link utilization above a threshold for some time period after which a limit will be enforced), limited radix policies (e.g., capping the number of TCP connections allowed at the same time), data scrubbing policies (e.g., defining a maximum time period that persistent data will remain stored before it is expunged), access policies (e.g., defining access to IP address as only being allowed via a proxy address outside of a subset), hardware policies (e.g., allowing an AVX instruction vector multiply to use a hardware offload rather than software interpolation), administrator policies (e.g., to only allow access to resource system objects or telemetry data to users having a system/infrastructure administrator role, or only allow create/delete operations on resource state tag objects for owners of a corresponding resource), and/or any other LCS policies that would be apparent one of skill in the art in possession of the present disclosure).

As such, the LCS information nodes 1304a-1304n may be configured to identify static LCS information (e.g., the LCS capabilities information discussed above) or dynamic LCS information (e.g., the LCS operating information discussed above that may be retrieved from sensor(s) that are coupled to the processing device 802a, networking device 804a, and storage device 806a that are used to provide the LCS 1202 and that may be updated in real-time in the LCS information node(s) 1304a-1304n), and may be user specific and/or updatable (e.g., the LCS policy information discussed above may be specific to particular users and/or may be updated for users as policies for those users change). As such, the updating of the LCS monitoring graph model 901 may include retrieving any information about the LCS 1202 identified by the LCS node 1302 and populating that information in the LCS information node(s) 1304a-1304n connected to the LCS node 1302, linking the LCS information node(s) 1304a-1304n connected to the LCS node 1302 to sensor(s) that report information about the resource devices that are used to provide the LCS 1202 identified by that LCS node 1302, and/or any other operations that one of skill in the art in possession of the present disclosure would recognize as enabling the functionality using the LCS monitoring graph models described below. However, while specific examples of LCS information identified by LCS information nodes has been described, one of skill in the art in possession of the present disclosure will appreciate how the LCS information nodes of the present disclosure may identify any information about an LCS while remaining within the scope of the present disclosure.

As will be appreciated by one of skill in the art in possession of the present disclosure, the resource devices used to provide the LCS 1202 may change through the provisioning of the LCS 1202, and the resource management system 304 may be configured to modify the LCS monitoring graph model 901 to remove resource device graph model nodes for resource devices that are unavailable for providing the LCS 1202, add “new” resource device graph model nodes for “new” resource devices that are used to provide the LCS 1202 and connect those “new” resource device graph model nodes to the LCS node 1302, and provide resource information graph model nodes for the “new” resource device graph model nodes similarly as described above. As such, the LCS monitoring graph model 901 may dynamically change to reflect the current provisioning of the LCS 1202.

The method 700 then proceeds to a subsequent iteration of block 712 where the resource management system performs one or more LCS monitoring operations for the LCS using the LCS monitoring graph model. As discussed in further detail below, in an embodiment of the subsequent iteration of block 712 and after updating the LCS monitoring graph model 901 at the subsequent iteration of block 710 for the LCS 1202 composed at the subsequent iteration of block 708, the resource management system 304 may perform any of a variety of LCS monitoring operations for the LCS 1202 using the LCS monitoring graph model 901. The specific example provided herein for the method 700 describes an embodiment in which the resource management system 304 composes and monitors a plurality of LCSs, and thus the composing of those LCSs is described herein before the discussion of the use of the LCS monitoring graph model 901 in the monitoring of those LCSs at block 712. However, while a discussion of the monitoring of a plurality of LCS by the resource management system 304 is described below, one of skill in the art in possession of the present disclosure will appreciate how a single LCS may be monitored by the resource management system 304 similarly as described below while remaining within the scope of the present disclosure as well.

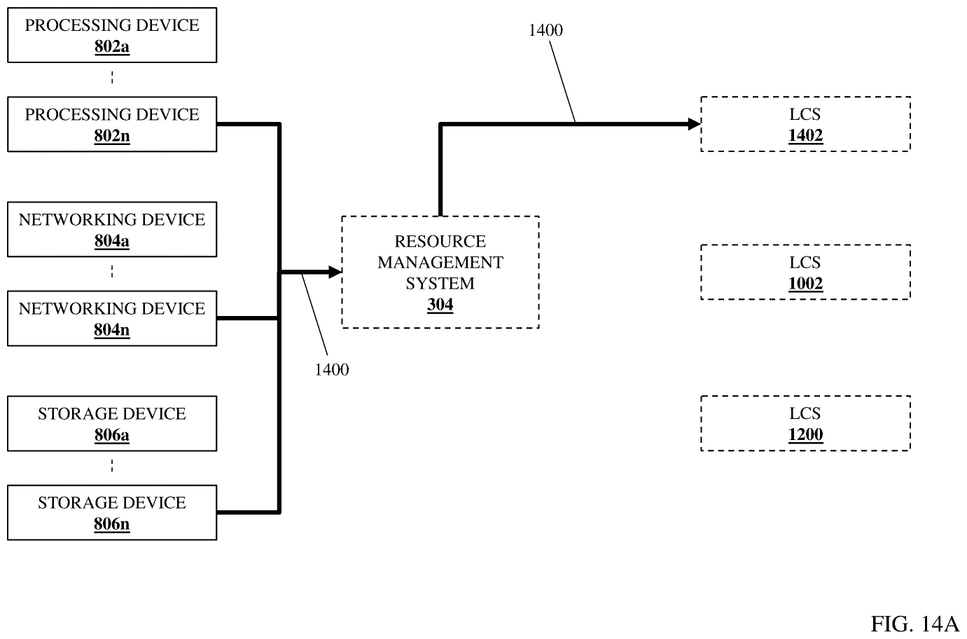

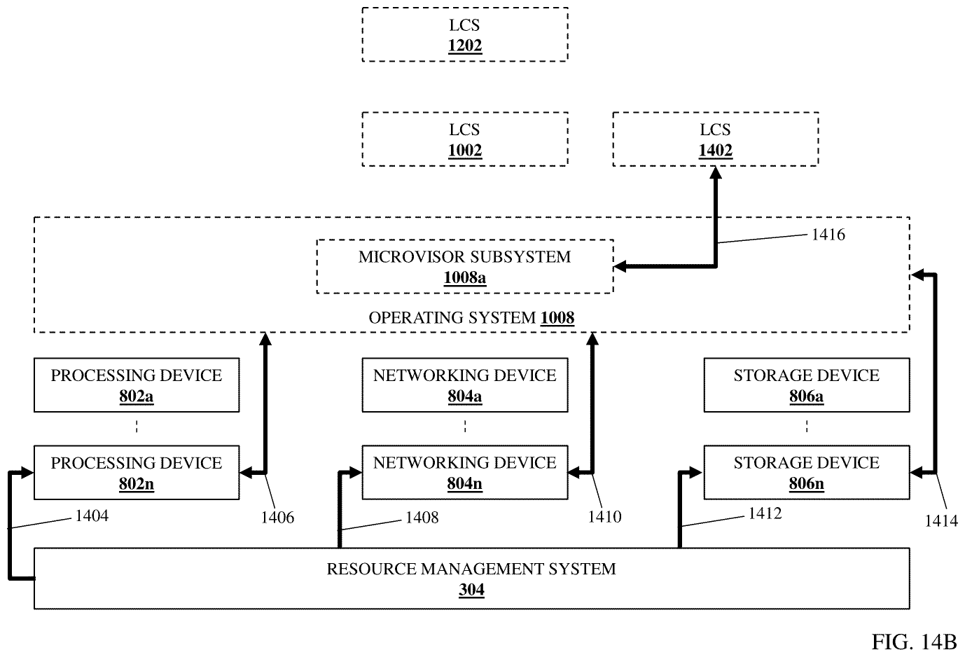

As such, following the composing of the LCS 1202 at the subsequent iteration of block 708 and the updating of the LCS monitoring graph model 901 at the subsequent iteration of block 710, the LCS 1202 may be monitored using the LCS monitoring graph model 901 and the method may return to decision block 706 to determine whether another instruction is received to provide another LCS similarly as described above. With reference to FIG. 14A and in response to receiving an instruction to provide an LCS during yet another subsequent iteration of decision block 706, the resource management system 304 may perform LCS composition operations 1400 that include composing an LCS 1402 using the processing device 802n, the networking device 804n, and the storage device 806n.

For example, as illustrated in FIG. 14B, the LCS composition operations 1400 performed by the resource management system 304 may include processing device configuration operations 1404 that configure the processing device 802n to perform processing operations 1406 to provide the LCS 1402 (e.g., in cooperation with the operating system 1008 including the microvisor subsystem 1008a that is provided using any of the processing devices 802a-802n (and corresponding memory devices, not illustrated) available to the resource management system 304 in, for example, one of the BMSs discussed above), networking device configuration operations 1408 that configure the networking device 804n to perform networking operations 1410 to provide networking for the LCS 1202 (e.g., by transmitting data to and from the LCS 1402), and storage device configuration operations 1412 that configure the storage device 806n to perform storage operations 1414 to provide storage for the LCS 1402 (e.g., by storing data utilized by the LCS 1402). The microvisor subsystem 1008a in the operating system 1008 may then operate using the processing device 802n, the networking device 804n, and the storage device 806n to perform LCS provisioning operations 1416 to provide the LCS 1402. However, while the composition of an LCS using the simplified example of resource devices provided by the processing devices 802a-802n, networking devices 804a-804n, and storage devices 806a-806n is provided herein, one of skill in the art in possession of the present disclosure will appreciate how LCSs may be composed using a variety of resource devices while remaining within the scope of the present disclosure as well.

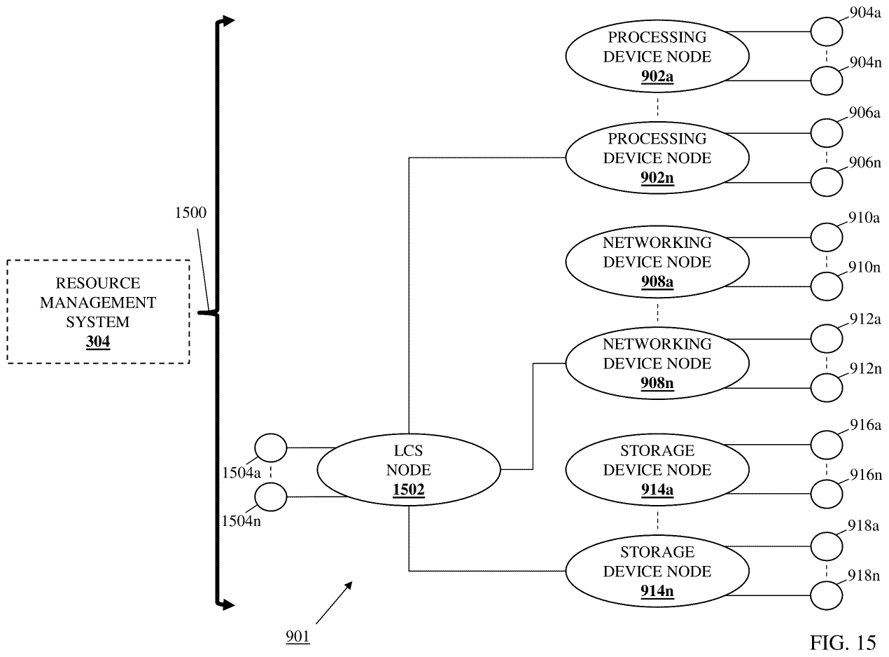

The method 700 then proceeds to yet another subsequent iteration of block 710 where the resource management system updates the LCS monitoring graph model. For example, with reference to FIG. 15, a specific example of LCS monitoring graph model update operations 1500 by the resource management system 304 are illustrated that provide for the updating of the LCS monitoring graph model 901 to include an LCS node 1502 for the LCS 1402 that was composed at the subsequent iteration of block 708. Furthermore, the LCS monitoring graph model 901 is also updated to provide an edge that connects the LCS node 1502 to the processing device node 902n that identifies the processing device 802n that was used to compose the LCS 1402, an edge that connects the LCS node 1502 to the networking device node 908n that identifies the networking device 804n that was used to compose the LCS 1402, and an edge that connects the LCS node 1502 to the storage device node 914n that identifies the storage device 806n that was used to compose the LCS 1402. Further still, the LCS monitoring graph model 901 is also updated to include a plurality of LCS information nodes 1504a-1504n that are each connected to the LCS node 1502 by a respective edge. As described in further detail below, the LCS information nodes 1504a-1504n may each be configured to identify information about the LCS 1402 identified by the LCS node 1502.

For example, any of the LCS information nodes 1504a-1504n may be LCS capability nodes that are configured to identify LCS capability information that describes capabilities of the LCS 1402 (e.g., system capabilities such as database provisioning capabilities, vector database provisioning capabilities, static web server provisioning capabilities, object storage provisioning capabilities, file hierarchical storage provisioning capabilities, and data movement (e.g., Direct Memory Access (DMA) provisioning capabilities; Artificial Intelligence (AI) capabilities such as Retrieval-Augmented Generation (RAG) Model (“XYZ”) provisioning capabilities, and Large Language Model (LLM) implementation provisioning capabilities; security capabilities such as OpenID Connect (OIDC) Authentication Connector provisioning capabilities, OpenTelemetry (OTEL) Trace Collector provisioning capabilities, Certificate Authority (CA) Verification provisioning capabilities, and Data Inspection Proxy provisioning capabilities; Quality of Service (QoS) provisioning capabilities that provide performance, scalability, availability, and serviceability needs for LCSs, and/or any other LCS capabilities that would be apparent one of skill in the art in possession of the present disclosure).

In another example, any of the LCS information nodes 1504a-1504n may be LCS operation nodes that are configured to identify LCS operating information that is configured to describe the current operation of the LCS 1402 (e.g., currently present and/or enabled capabilities for the LCS 1402, capability dependencies (e.g., name and version) required for the LCS 1402, configuration metadata for the LCS 1402, an Internet Protocol (IP) address for the LCS 1402, a name of the LCS 1402, a cryptographic or otherwise unique identification for the LCS 1402, credentials and account information for the LCS 1402, tenant owner information for the LCS 1402, LCS runtime policy information for the LCS 1402, and/or any other LCS operating information that would be apparent one of skill in the art in possession of the present disclosure).

In yet another example, any of the LCS information nodes 1504a-1504n may be LCS policy nodes that are configured to identify LCS policy information that describes policies for using the LCS 1402 (e.g., CPU burst policies (e.g., to allow CPU operation above a threshold for some time period after which a limit will be enforced), networking burst policies (e.g., to allow link utilization above a threshold for some time period after which a limit will be enforced), limited radix policies (e.g., capping the number of TCP connections allowed at the same time), data scrubbing policies (e.g., defining a maximum time period that persistent data will remain stored before it is expunged), access policies (e.g., defining access to IP address as only being allowed via a proxy address outside of a subset), hardware policies (e.g., allowing an AVX instruction vector multiply to use a hardware offload rather than software interpolation), administrator policies (e.g., to only allow access to resource system objects or telemetry data to users having a system/infrastructure administrator role, or only allow create/delete operations on resource state tag objects for owners of a corresponding resource), and/or any other LCS policies that would be apparent one of skill in the art in possession of the present disclosure).

As such, the LCS information nodes 1504a-1504n may be configured to identify static LCS information (e.g., the LCS capabilities information discussed above) or dynamic LCS information (e.g., the LCS operating information discussed above that may be retrieved from sensor(s) that are coupled to the processing device 802n, networking device 804n, and storage device 806n that are used to provide the LCS 1402 and that may be updated in real-time in the LCS information node(s) 1504a-1504n), and may be user specific and/or updatable (e.g., the LCS policy information discussed above may be specific to particular users and/or may be updated for users as policies for those users change). As such, the updating of the LCS monitoring graph model 901 may include retrieving any information about the LCS 1402 identified by the LCS node 1502 and populating that information in the LCS information node(s) 1504a-1504n connected to the LCS node 1502, linking the LCS information node(s) 1504a-1504n connected to the LCS node 1502 to sensor(s) that report information about the resource devices that are used to provide the LCS 1402 identified by that LCS node 1502, and/or any other operations that one of skill in the art in possession of the present disclosure would recognize as enabling the functionality using the LCS monitoring graph models described below. However, while specific examples of LCS information identified by LCS information nodes has been described, one of skill in the art in possession of the present disclosure will appreciate how the LCS information nodes of the present disclosure may identify any information about an LCS while remaining within the scope of the present disclosure.

As will be appreciated by one of skill in the art in possession of the present disclosure, the resource devices used to provide the LCS 1402 may change through the provisioning of the LCS 1402, and the resource management system 304 may be configured to modify the LCS monitoring graph model 901 to remove resource device graph model nodes for resource devices that are unavailable for providing the LCS 1402, add “new” resource device graph model nodes for “new” resource devices that are used to provide the LCS 1402 and connect those “new” resource device graph model nodes that are providing the LCS 1402, and connect those “new” resource device graph model nodes to corresponding resource information graph model nodes similarly as described above. As such, the LCS monitoring graph model 901 may dynamically change to reflect the current provisioning of the LCS 1402.

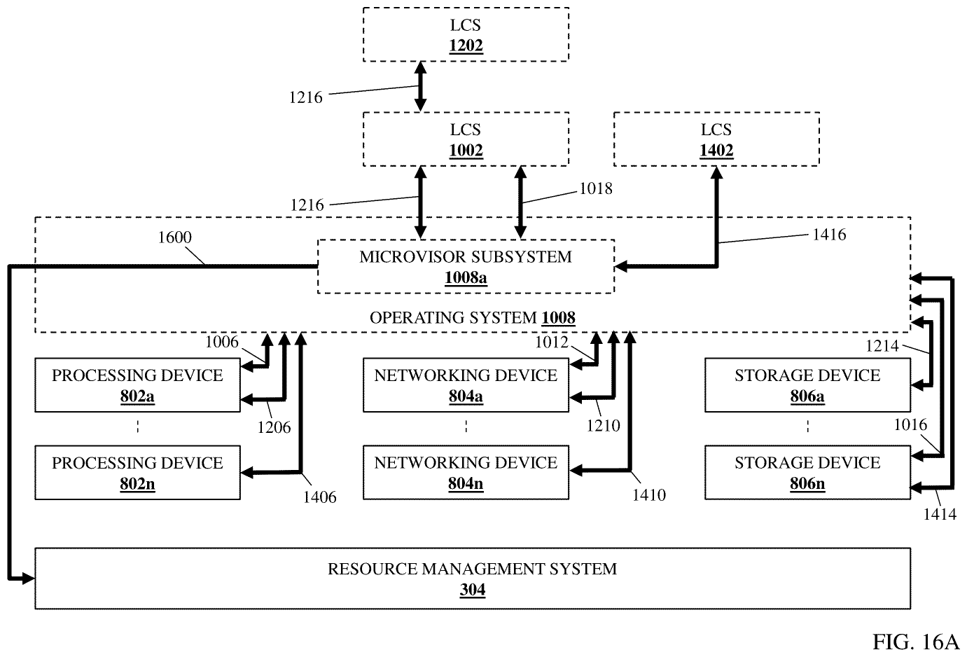

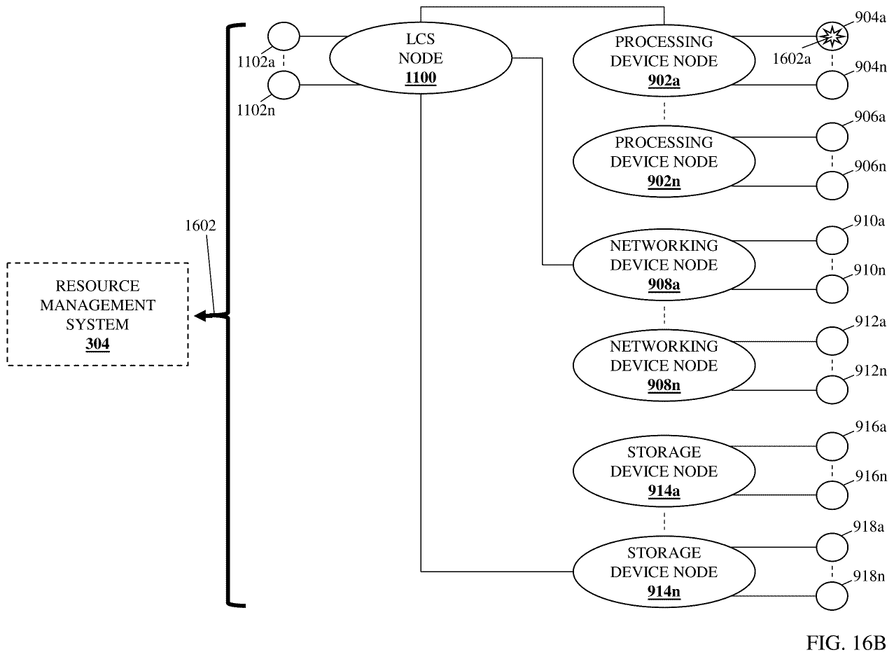

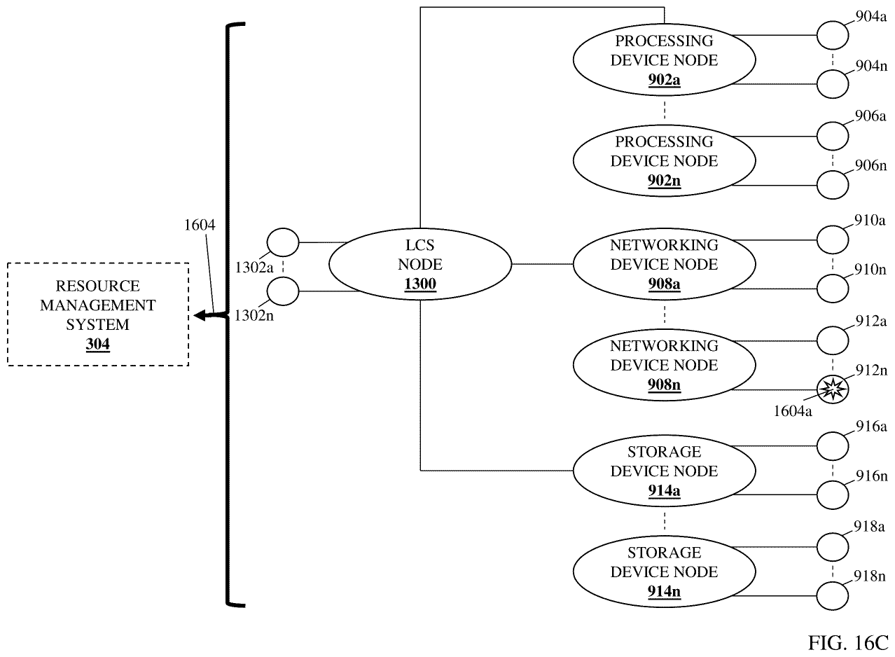

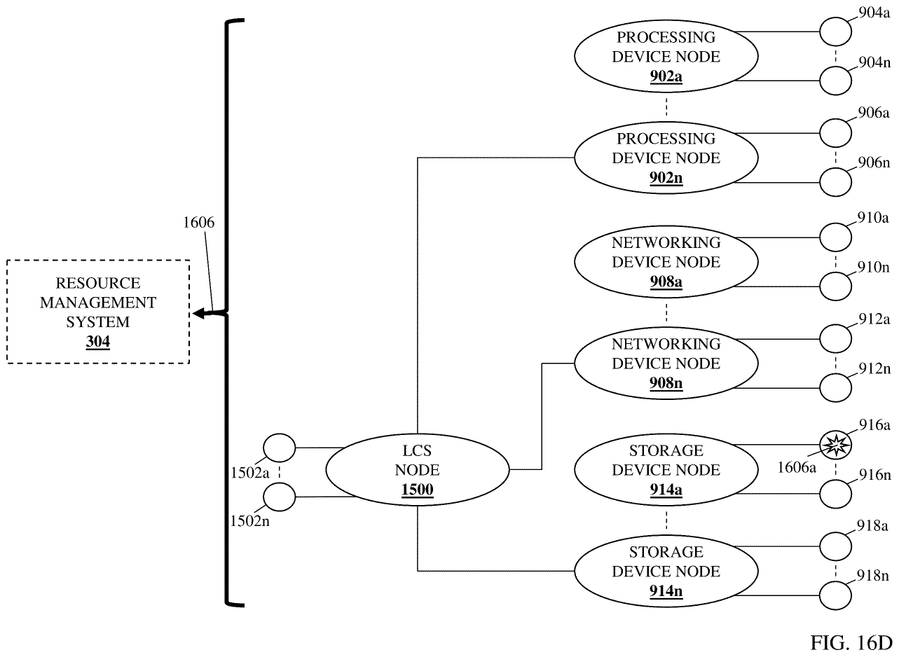

An example of the resource management system 304 using the LCS monitoring graph model 901 to monitor the LCSs 1002, 1202, and 1402 at block 712 will now be provided, but as described above, the monitoring of a single LCS using an LCS monitoring graph model generated and updated for that LCS similarly as described below will fall within the scope of the present disclosure as well. As can be seen in FIG. 16A, the microvisor subsystem 1008a in the operating system 1008 may perform the LCS provisioning operations 1018 to provide the LCS 1002, with the microvisor subsystem 1008a using the processing device 802a to perform the processing operations 1006 for the LCS 1002, the networking device 804a to perform the networking operations 1012 for the LCS 1002, and the storage device 806n to perform the storage operations 1016 for the LCS 1002.

As can also be seen in FIG. 16A, the microvisor subsystem 1008a in the operating system 1008 may perform the LCS provisioning operations 1216 to provide the LCS 1202, with the microvisor subsystem 1008a using the processing device 802a to perform the processing operations 1206 for the LCS 1202, the networking device 804a to perform the networking operations 1210 for the LCS 1202, and the storage device 806a to perform the storage operations 1214 for the LCS 1202. As can also be seen in FIG. 16A, the microvisor subsystem 1008a in the operating system 1008 may perform the LCS provisioning operations 1416 to provide the LCS 1402, with the microvisor subsystem 1008a using the processing device 802n to perform the processing operations 1406 for the LCS 1402, the networking device 804n to perform the networking operations 1410 for the LCS 1402, and the storage device 806n to perform the storage operations 1414 for the LCS 1402.

Furthermore, the microvisor subsystem 1008a in the operating system 1008 may also perform LCS operating information provisioning operations 1600 that include reporting any information generated in response to operation of the LCS provisioning operations 1018, 1216, and 1416; the processing operations 1006, 1206, and 1406; the networking operations 1012, 1210, and 1410; and the storage operations 1214, 1016, and 1414 to the resource management system 304. For example, at block 712, the microvisor subsystem 1008a may monitor any sensors provided for the processing devices 802a-802n, the networking devices 804a-804n, the storage devices 806a-806n, and the LCSs 1002, 1202, and 1402, and report any information generated by those sensors to the resource management system 304 as part of the LCS monitoring information reporting operations 1600. However, while a specific example of the provisioning of operating information generated as part of the provisioning of LCSs has been provided one of skill in the art in possession of the present disclosure will appreciate how a variety of operating information may be generated as part of the provisioning of LCSs and may be provided to the microvisor subsystem of the present disclosure while remaining within the scope of the present disclosure as well.

As will be appreciated by one of skill in the art in possession of the present disclosure, the operating information received from the microvisor subsystem 1008a by the resource management system 304 may then be provided in the LCS monitoring graph model 901 in the processing device information nodes 904a-904n and 906a-906n that are configure to identify that operating information, the networking device information nodes 910a-910n and 912a-912n that are configure to identify that operating information, the storage device information nodes 916a-916n and 918a-918n that are configured to identify that operating information, and the LCS information nodes 1102a-1102n, 1302a-1302n, and 1502a-1502n that are configured to identify that operating information. As such, one of skill in the art in possession of the present disclosure will appreciate how the CLS monitoring graph model 901 provides a “digital twin” of the LCS provisioning subsystem 300 with nodes that identify each of the resource devices included therein and the LCSs provided by those resource devices, as well as nodes that identify the capabilities, current operation, and policies of each of those resource devices and LCSs. Furthermore, operating information may be dynamically updated in real time for each of those resource devices and LCSs, allowing for the monitoring of their operation, the determination of whether their operation complies with operating policies, and/or otherwise allowing any changes to resource devices and LCSs to be instantly identified and correlated.

With reference to FIG. 16B, an example of the resource management system 304 performing LCS monitoring operations 1602 is provided in which operating information identified by the processing device information node 904a may be compared to policy information identified by the processing device information node 904n to determine that the current operation of the processing device 802a identified by the processing device node 902a violated a policy (e.g., as indicated by element 1602a). For example, the comparison of the operating information identified by the processing device information node 904a to the policy information identified by the processing device information node 904n may identify that the current operation of the processing device 802a identified by the processing device node 902a has exceeded a threshold processing device operating level (e.g., a user has exceeded an amount of processing they purchased for the LCS 1002 identified by the LCS node 1100) and, in response, the resource management system 304 may throttle the processing device 802a, activate a billing system to bill a user for exceeding the threshold processing device operating level, and/or perform other LCS monitoring operations that would be apparent to one of skill in the art in possession of the present disclosure.

With reference to FIG. 16C, an example of the resource management system 304 performing LCS monitoring operations 1604 is provided in which operating information identified by the networking device information node 912n may be compared to policy information identified by the networking device information node 912a to determine that the current operation of the networking device 804n identified by the networking device node 908n violated a policy (e.g., as indicated by element 1604a). For example, the comparison of the operating information identified by the networking device information node 912n to the policy information identified by the networking device information node 912a may identify that the current operation of the networking device 804n identified by the networking device node 908n has exceeded a threshold networking device operating level (e.g., a user has exceeded an amount of networking bandwidth they purchased for the LCS 1202 identified by the LCS node 1300) and, in response, the resource management system 304 may throttle the networking device 804n, activate a billing system to bill a user for exceeding the threshold networking device operating level, and/or perform other LCS monitoring operations that would be apparent to one of skill in the art in possession of the present disclosure.

With reference to FIG. 16D, an example of the resource management system 304 performing LCS monitoring operations 1606 is provided in which operating information identified by the storage device information node 916a may be compared to policy information identified by the storage device information node 916n to determine that the current operation of the storage device 806a identified by the storage device node 914a violated a policy (e.g., as indicated by element 1606a). For example, the comparison of the operating information identified by the storage device information node 916a to the policy information identified by the storage device information node 916n may identify that the current operation of the storage device 806a identified by the storage device node 914a has exceeded a threshold storage device operating level (e.g., a user has exceeded a storage capacity they purchased for the LCS 1402 identified by the LCS node 1500) and, in response, the resource management system 304 may throttle the storage device 806a, activate a billing system to bill a user for exceeding the threshold storage device operating level, and/or perform other LCS monitoring operations that would be apparent to one of skill in the art in possession of the present disclosure.

However, while several specific examples of the monitoring of the LCSs 1002, 1202, and 1402 using the LCS monitoring graph model 901 to determine when the operation of processing devices, networking devices, and/or storage devices exceed policies have been described, one of skill in the art in possession of the present disclosure will appreciate how such monitoring may determine when the operation of the LCSs 1002, 1303, and 1402 exceeds policies as well (e.g., detecting that an LCS has exceeded a link utilization threshold in a network burst policy such that the network link must be throttled until overall conditions improve, identifying violation of a threat intelligence policy by an LCS such as anomalous event(s) or traffic patterns on an application provided by the LCS or workload from non-administrator user or from an administrator user from a different geographic location, etc.) Furthermore, while the examples above focus on the use of the LCS monitoring graph model 901 to perform operation policy compliance determinations, one of skill in the art in possession of the present disclosure will appreciate how the LCS monitoring graph model of the present disclosure may be used to monitor any information about the LCSs being provided by an LCS provisioning system while remaining within the scope of the present disclosure as well.

For example, one of skill in the art in possession of the present disclosure will appreciate how the operation of the processing devices, networking devices, and/or storage devices to provide the LCSs 1002, 1202, and 1402 may be stored in a database by the resource management system 304 and used to forecast the future use of the processing devices 802a-802n, networking devices 804a-804n, and/or storage devices 806a-806n for providing LCSs. Furthermore, one of skill in the art in possession of the present disclosure will also appreciate how operation of the processing devices 802a-802n, networking devices 804a-804n, and/or storage devices 806a-806n used to provide the LCSs 1002, 1202, and 1402 may be used to identify and remediate configuration “drifts” (i.e., differences between the current operation and a desired operation) by those processing devices, networking devices, and/or storage devices.

As such, the resource information graph model nodes for a resource device graph model node associated with a resource device may be configured as sensors or triggers, and one of skill in the art in possession of the present disclosure will appreciate how the resource information graph model nodes may be used to update performance counters, capture telemetry metrics, and/or may be used to perform other monitoring operations known in the art. To provide a specific example, the resource information graph model nodes described above allow the processing and memory usage by the “nested” LCS 1202 to be tracked when the “nested” LCS 1202 begins providing a virtual machine and until that LCS is finished providing that virtual machine, and allows that processing and memory usage to be distinguished from the processing and memory usage of the LCS 1002 that is providing that “nested” LCS 1202 (i.e., using the same processing device 802a).

Furthermore, the resource information graph model nodes allow the runtime transient state of each resource device used to provide an LCS to be monitored in order to analyze the behavior of the LCS at discrete levels for use inferring causality of any event that occurs with the LCS or the resource devices that are used to provide that LCS. Further still, graph embedding techniques may be used with the LCS monitoring model graphs of the present disclosure to translate those LCS monitoring model graphs as vector representations in order to, for example, determine if processing device cores providing an LCS are reporting higher than normal processing cycle usage states that will cause performance issues or effect the stability of the LCS, with vector embedding used to detect any potential for “drift” in order to allow for measures to be performed to prevent such drift.

Thus, systems and methods have been described that provide a graph model that may be used to monitor the operation of an LCS that has been composed using a plurality of resource devices. The graph-modeling-based LCS monitoring system of the present disclosure may include a resource management system coupled to resource devices. The resource management system identifies the resource devices and generates an LCS monitoring graph model with resource device nodes identifying the resource devices, and respective resource operation nodes connected via edges to those resource device nodes and configured to identify a current operation of their identified resource devices. The resource management system then composes an LCS using a first subset of the resource devices and, in response, updates the LCS monitoring graph model to include an LCS node that identifies the LCS and that is connected to the resource device nodes identifying the first subset of the resource devices. The resource management system then uses information identified from respective resource operation node(s) connected to the resource device nodes identifying the first subset of the resource devices to perform LCS monitoring operation(s) for the LCS. As such, relatively low-level, real-time monitoring of LCSs may be performed to understand and report the operations of the resource devices providing the LCS, enable the billing of the utilization of any particular resource devices, forecast the future use of resource devices for LCSs, remediate configuration “drifts” by resource devices that provide LCSs, and/or provide other monitoring benefits that would be apparent to one of skill in the art in possession of the present disclosure.

Thus, one of skill in the art in possession of the present disclosure will appreciate how the systems and methods of the present disclosure provide for the granular tracking of LCS provisioning using physical or logical resource devices in order to monitor the transient changes in the LCS and identify diverse correlations between the distributed components used to provide the LCS. Furthermore, scalability and performance efficiency benefits may be achieved by applying a generic resource information schema across a variety of types of resource devices and leveraging inferencing capabilities of graph embeddings. As will be appreciated by one of skill in the art in possession of the present disclosure, the “digital twinning” of LCS provisioning systems and the LCSs they provide enables the discrete accounting of different feature utilization by users.

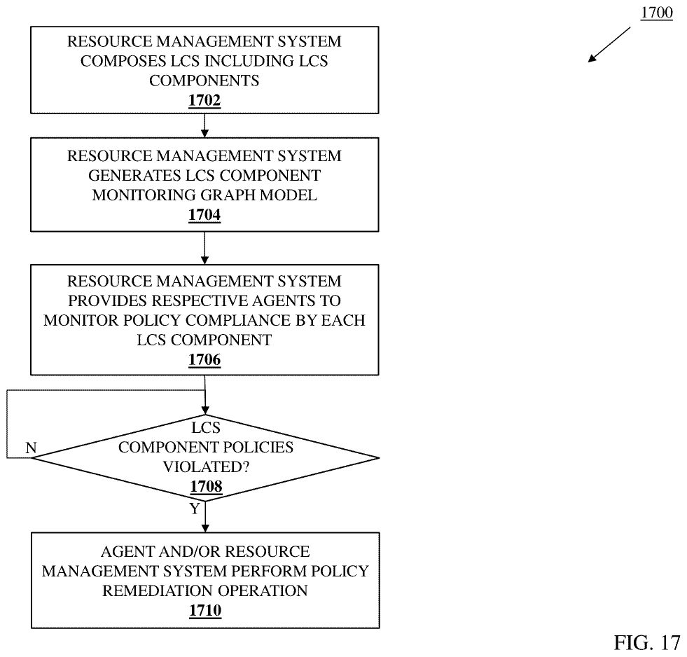

With reference to FIG. 17, an embodiment of a method 1700 for monitoring policies for Logically Composed System (LCS) components using graph modeling is illustrated. As described below, the systems and methods of the present disclosure provide agents to monitor each of a plurality of LCS components of an LCS to determine whether policies for each of those LCS components are violated. For example, the graph-modeling-based LCS component policy monitoring system of the present disclosure may include resource devices coupled to a resource management system that uses the resource devices to compose an LCS that includes LCS components. The resource management system then generates an LCS component monitoring graph model that includes respective LCS component graph model nodes identifying each LCS component, and a respective LCS component policy graph model node connected to each respective LCS component graph model node via a respective graph model edge and identifying a policy for the LCS component identified by its connected respective LCS component graph model node. The resource management system then provides, for each of the LCS components, a respective agent that monitors that LCS component and determine whether the policy identified by the LCS component policy graph model node connected to the LCS component graph model node identifying that LCS component in the LCS component monitoring graph model is violated.

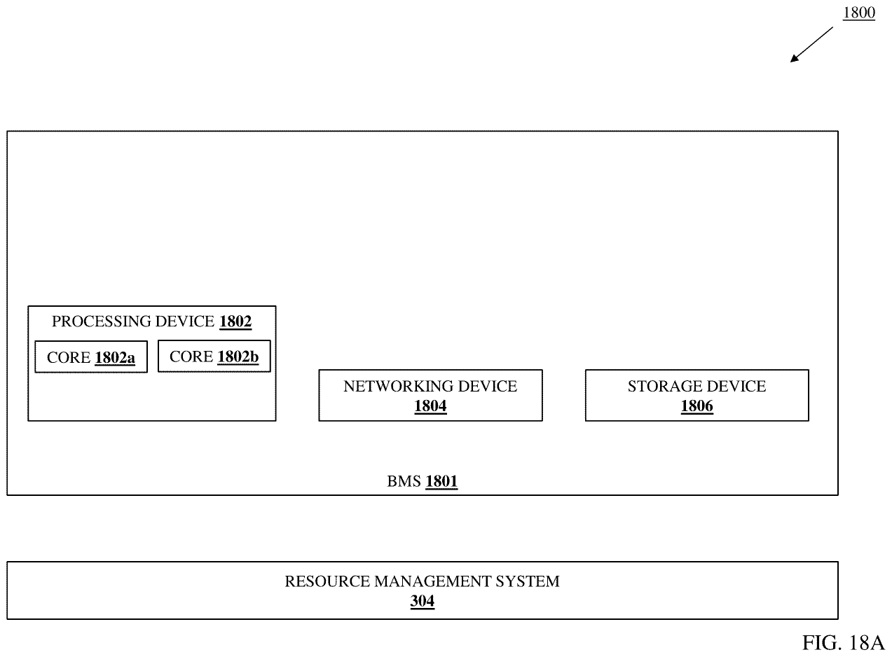

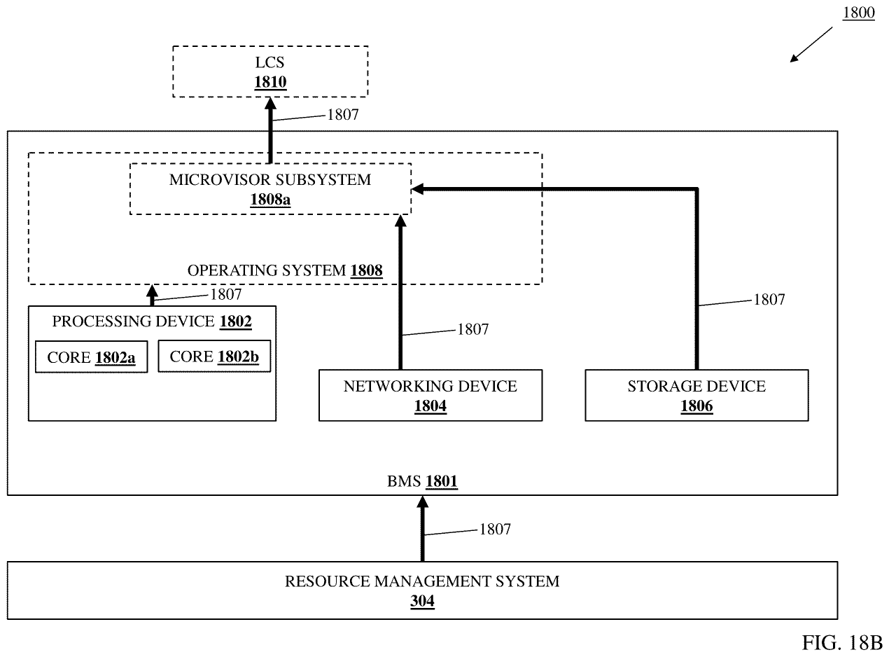

The method 1700 begins at block 1702 where a resource management system composes an LCS including LCS components. With reference to FIG. 18A, an embodiment of an LCS provisioning subsystem 1800 is illustrated that may provide the LCS provisioning subsystem 300 discussed above with reference to FIG. 3, with each resource system 306a-306c provided by the resource system 400 discussed above with reference to FIG. 4. In the illustrated embodiment, the LCS provisioning subsystem 1800 includes the resource management system 304 discussed above with reference to FIG. 3 coupled to a plurality of resource devices (e.g., the resource devices 404a-404c in the resource systems 306a-306c/400) that are provided by a BMS 1801 including a processing device 1802 having cores 1802a and 1802b, a networking device 1804, and a storage device 1806. However, while specific resource devices provide by a BMS and its components are illustrated and described in the examples below, one of skill in the art in possession of the present disclosure will appreciate how a variety of other resource devices in a variety of other configurations will fall within the scope of the present disclosure.

With reference to FIG. 18B, in an embodiment of block 1702, the resource management system 304 may perform LCS provisioning operations 1807 that include configuring the resource devices provided by the BMS 1801, the processing device 1802, the cores 1802a and 1802b, the networking device 1804, and the storage device 1806 to provide an LCS similarly as described above, causing the processing system 1802 to provide an operating system 1808 including a microvisor subsystem 1808a that utilizes the cores 1802a and 1802b in the processing device 1802, the networking device 1804, and the storage device 1806 to provide an LCS 1810. As will be appreciated by one of skill in the art in possession of the present disclosure, the LCS 1810 includes a plurality of LCS components that are provided by the BMS 1801, the processing device 1802, the cores 1802a and 1802b, the networking device 1804, the storage device 1806, the operating system 1808, and the microvisor subsystem 1808a in the examples illustrated and described below.

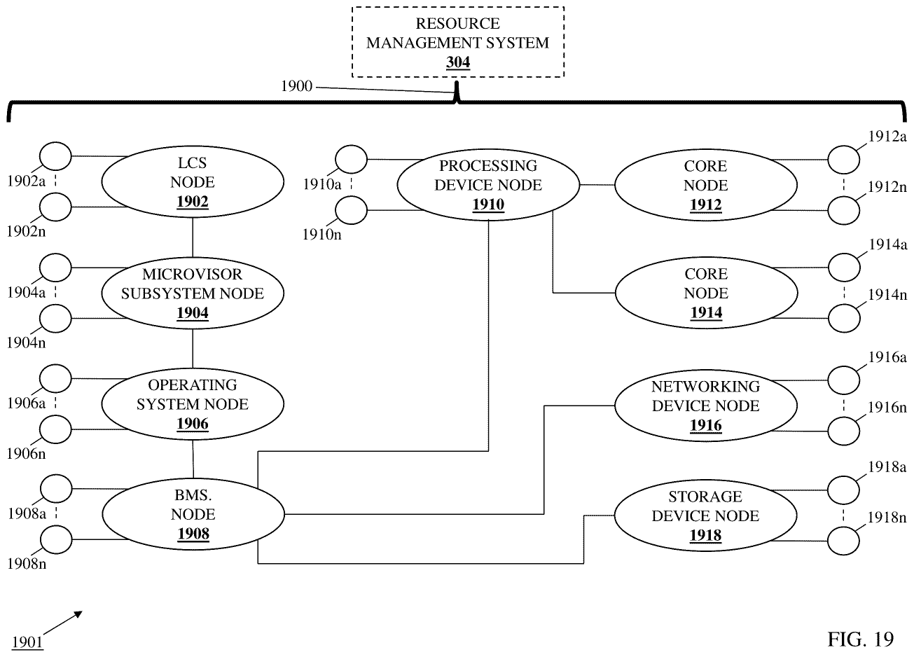

The method 1700 then proceeds to block 1704 where the resource management system generates an LCS component policy monitoring graph model. With reference to FIG. 19, in an embodiment of block 1704, the resource management system 304 may perform LCS component policy monitoring graph model generation operations 1900 to generate an LCS component policy monitoring graph model 1901 for the LCS that was composed at block 1702. As will be appreciated by one of skill in the art in possession of the present disclosure, the LCS component policy monitoring graph model 1901 may be generated at block 1704 similarly as described above for the generation and updating of the LCS monitoring graph model at blocks 704 and 710 of the method 700.

In a specific example for the LCS 1810, the resource management system 304 may generate the LCS component policy monitoring graph model 1901 that includes a respective LCS component graph model node for each LCS component provided for the LCS 1810, with each respective LCS component graph model node connected via a respective edge to a plurality of LCS component policy graph models nodes that identify respective policies for the LCS component identified by their connected LCS component graph model node. Similarly as described above, in some embodiments the LCS component policy monitoring graph model 1901 may be stored entirely in memory (or other storage) in the resource management system 304, while in other embodiments subgraphs of the LCS component policy monitoring graph model 1901 may be stored by agents discussed below on the resource systems 306a-306c that include the resource devices that provide the LCS components for the LCS 1810, with those agents tracking changes to their LCS components to update their subgraphs of the LCS component policy monitoring graph model 1901, enforcing local policies for their LCS components, and/or performing other local operations that would be apparent to one of skill in the art in possession of the present disclosure. As such, the resource management system 304 may operate as a “centralized” LCS component policy monitoring system using the LCS component policy monitoring graph model 1901, with agents provided on distributed resource systems updating their subgraphs and synchronizing the subgraphs with the resource management system 304, while performing state management, policy enforcement, and/or other local operations on their resource systems.

With reference to FIG. 19, the specific example of the LCS component policy monitoring graph model 1901 includes an LCS node 1902 for the LCS 1810, and a plurality of LCS policy nodes 1902a and up to 1902n that are each connected to the LCS node 1902 by a respective edge and that may each identify a policy for the LCS 1810. For example, policies for the LCS 1810 may include policies that require the LCS 1810 to utilize processor cores and corresponding memory devices for the same physical processor without a Non-Uniform Memory Access (NUMA) hop, policies that require the LCS 1810 to utilize non-contiguous and non-local storage resources, May policies that require the LCS 1810 to utilize processors at a load average exceeding 70% of a duty cycle for 30 seconds in a 5 minute period, policies that require the LCS 1810 to perform a data compression function utilizing a high performance physical accelerator device for a data compression function for 10 minutes in a 60 minute period and utilizing a software accelerator subsystem for the remainder of that period, policies that require the LCS 1810 to be rebooted or reinitialized every 7 days of uptime, and/or other LCS policies that would be apparent to one of skill in the art in possession of the present disclosure.

The LCS component policy monitoring graph model 1901 also includes a microvisor subsystem node 1904 for the microvisor subsystem 1808a (e.g., an example of one of the LCS component graph model nodes discussed above) that is connected to the LCS node 1902 by an edge, and a plurality of microvisor subsystem policy nodes 1904a and up to 1904n (e.g., each of which provides an example of one of the LCS component policy graph model nodes discussed above) that are each connected to the microvisor subsystem node 1904 by a respective edge and that may each identify a policy for the microvisor subsystem 1808a. For example, policies for the microvisor subsystem 1808a may include policies that require memory systems that were previously used to provide an LCS be scrubbed before providing a new LCS, policies that require that multiple LCSs provided for the same user see the same Direct Memory Access (DMA) device when utilizing DMA but do not see each other as DMA endpoints (with that DMA device seen as shared memory by the user), policies that monitor LCS IO rates that exceed 70% of a threshold, policies that prevent an LCS from consuming more than 25% of processing resources of a processing system in a pattern that matches a “Power Virus” pattern (e.g., long-running power-hungry instructions in loops), and/or other microvisor subsystem policies that would be apparent to one of skill in the art in possession of the present disclosure.

The LCS component policy monitoring graph model 1901 also includes an operating system node 1906 for the operating system 1808 (e.g., an example of one of the LCS component graph model nodes discussed above) that is connected to the microvisor subsystem node 1904 by an edge, and a plurality of operating system policy nodes 1906a and up to 1906n (e.g., each of which provides an example of one of the LCS component policy graph model nodes discussed above) that are each connected to the operating system node 1906 by a respective edge and that may each identify a policy for the operating system 1808. For example, policies for the operating system 1808 may include policies that any particular service must be started at time of boot and must always restart, policies that any particular service may never run at the same time as another particular service, policies that a device driver must be checked for updates every 24 hours, policies that updates must be applied followed by a soft reset of a device regardless of its operation, policies that hung processes not responding to a watchdog mechanism within 30 seconds will be restarted, and/or other operating system policies that would be apparent to one of skill in the art in possession of the present disclosure.

The LCS component policy monitoring graph model 1901 also includes a BMS node 1908 for the BMS 1801 (e.g., an example of one of the LCS component graph model nodes discussed above) that is connected to the microvisor subsystem node 1904 by an edge, and a plurality of BMS policy nodes 1908a and up to 1908n (e.g., each of which provides an example of one of the LCS component policy graph model nodes discussed above) that are each connected to the BMS node 1908 by a respective edge and that may each identify a policy for the BMS 1801. For example, policies for the BMS 1801 may include policies that the temperature for inlet cooling air cannot exceed a threshold for more than a threshold number of minutes, policies that a total power consumption may not exceed a threshold for more than a threshold number of seconds, policies that an operating system may not boot unless all components pass secure trust validation, policies that the operation of a BMS must be stopped if a resource device in the BMS does not power on or complete a health check, and/or other BMS policies that would be apparent to one of skill in the art in possession of the present disclosure.

The LCS component policy monitoring graph model 1901 also includes a processing device node 1910 for the processing device 1802 (e.g., an example of one of the LCS component graph model nodes discussed above) that is connected to the BMS node 1908 by an edge, and a plurality of processing device policy nodes 1910a and up to 1910n (e.g., each of which provides an example of one of the LCS component policy graph model nodes discussed above) that are each connected to the processing device node 1910 by a respective edge and that may each identify a policy for the processing device 1802. For example, policies for the processing device 1802 may include polices that level one processor cache lines may not be shared by two different users, policies that a level two processor cache must reserve space for each LCS, policies that a processor may not use power boot states for a particular user, policies that a processor may enable the use of a particular instruction for an LCS, and/or other processing device policies that would be apparent to one of skill in the art in possession of the present disclosure.

The LCS component policy monitoring graph model 1901 also includes a core node 1912 for the core 1802a (e.g., an example of one of the LCS component graph model nodes discussed above) that is connected to the processing device node 1910 by an edge, and a plurality of core policy nodes 1912a and up to 1912n (e.g., each of which provides an example of one of the LCS component policy graph model nodes discussed above) that are each connected to the core node 1912 by a respective edge and that may each identify a policy for the core 1802a. For example, policies for the core 1802a may include the policies described above for the processing device 1802, and/or any other core policies that would be apparent to one of skill in the art in possession of the present disclosure.

The LCS component policy monitoring graph model 1901 also includes a core node 1914 for the core 1802b (e.g., an example of one of the LCS component graph model nodes discussed above) that is connected to the processing device node 1910 by an edge, and a plurality of core policy nodes 1914a and up to 1914n (e.g., each of which provides an example of one of the LCS component policy graph model nodes discussed above) that are each connected to the core node 1914 by a respective edge and that may each identify a policy for the core 1802b. For example, policies for the core 1802b may include the policies described above for the processing device 1802, and/or any other core policies that would be apparent to one of skill in the art in possession of the present disclosure.

The LCS component policy monitoring graph model 1901 also includes a networking device node 1916 for the networking device 1804 (e.g., an example of one of the LCS component graph model nodes discussed above) that is connected to the BMS node 1908 by an edge, and a plurality of networking device policy nodes 1916a and up to 1916n (e.g., each of which provides an example of one of the LCS component policy graph model nodes discussed above) that are each connected to the networking device node 1916 by a respective edge and that may each identify a policy for the networking device 1804. For example, policies for the networking device 1804 may include policies that a networking device must broadcast a Link Layer Discovery Protocol (LLDP) to peers, policies that a network device must authenticate an 802.1x identity, policies that require a networking device to attach to a particular Virtual Local Area Network (VLAN) for a particular user, policies that an Remote Direct Memory Access (RDMA) capability of a networking device will only be available for a particular user, and/or other networking device policies that would be apparent to one of skill in the art in possession of the present disclosure.

The LCS component policy monitoring graph model 1901 also includes a storage device node 1918 for the storage device 1806 (e.g., an example of one of the LCS component graph model nodes discussed above) that is connected to the BMS node 1908 by an edge, and a plurality of storage device policy nodes 1918a and up to 1918n (e.g., each of which provides an example of one of the LCS component policy graph model nodes discussed above) that are each connected to the storage device node 1918 by a respective edge and that may each identify a policy for the storage device 1806. For example, policies for the storage device 1806 may include policies that a media write failure rate that exceeds 1 failure per day will cause a storage device to be marked as faulted, policies that a deduplication capability is only available for particular user, policies that a write speed for a particular user is guaranteed at 10 MB/s, policies that particular users may not exceed a maximum of 10 MB/s for more than 30 seconds before being throttled, policies that storage devices must support synchronous writes to a backup device for all write I/O's, polices that a maximum queue depth may not exceed 1 ms of latency, and/or other storage device policies that would be apparent to one of skill in the art in possession of the present disclosure.

As will be appreciated by one of skill in the art in possession of the present disclosure, the LCS component policy graph model 1901 may provide a “policy stack” for any LCS component of the LCS 1810, with the LCS node 1902 and LCS policy nodes 1902a-1902n providing a “root” “anchor” policy object for the policy stack. For example, the LCS component policy graph model 1901 may provide the core 1802a of the processing device 1802 with a policy stack that includes policies for the LCS node 1902, policies for the microvisor subsystem node 1904, policies for the operating system node 1906, policies for the BMS node 1908, policies for the processing device node 1910, and policies for the core node 1912. In some examples, a policy stack may be generated by defining a policy for an LCS component, and then applying that policy to a policy stack that includes that LCS component (e.g., a policy that is generated for the LCS 1810 and defines how the LCS may use processing resources may be applied to the processing device node 1910 and the core nodes 1912 and 1914).

As such, policies identified by the LCS component policy graph model nodes may include security policies (e.g., the core policy nodes 1912a-1912n for the core node 1912 may identify features of the core 1802a that are available to the LCS 1810), operational policies (e.g., the core policy nodes 1912a-1912n for the core node 1912 may identify whether the core 1802a may be utilized by LCSs other than the LCS 1810), and/or any other policies that would be apparent to one of skill in the art in possession of the present disclosure. Furthermore, policies identified by the LCS component policy graph model nodes may be LCS-provider-based (e.g., policies directed by the LCS provider), or LCS-user-based (e.g., policies directed by the LCS user, or used to satisfy the workload intent received from the LCS user). However, while several examples of policies have been provided, one of skill in the art in possession of the present disclosure will appreciate how any LCS components policies may be provided for any LCS components while remaining within the scope of the present disclosure.

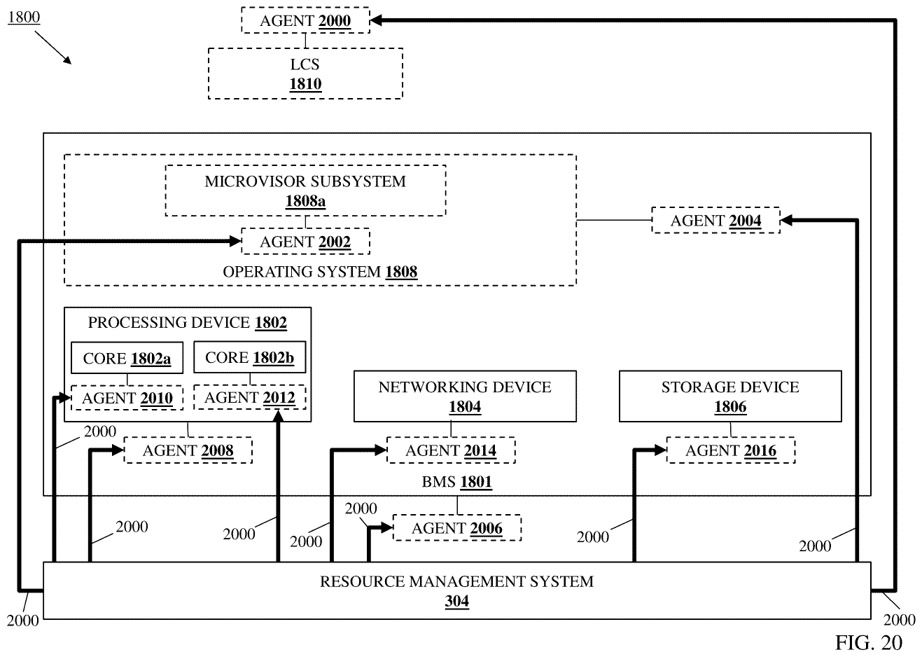

The method 1700 then proceeds to block 1706 where the resource management system provides respective agents to monitor policy compliance by each LCS component. With reference to FIG. 20, in an embodiment of block 1706, the resource management system 304 may perform agent provisioning operations 2000 that include providing an agent 2000 for the LCS 1810, providing an agent 2002 for the microvisor subsystem 1808a, providing an agent 2004 for the operating system 1808, providing an agent 2006 for the BMS 1801, providing an agent 2008 for the processing device 1802, providing an agent 2010 for the core 1802a, providing an agent 2012 for the core 1802b, providing an agent 2014 for the networking device 1804, and providing an agent 2016 for the storage device 1806.

As will be appreciated by one of skill in the art in possession of the present disclosure, the agents may be provided for the LCS components by providing those agents using that LCS component (e.g., the agent 2000 may be provided using the LCS 1810, the agent 2002 may be provided using the microvisor subsystem 1808a, the agent 2004 may be provided using the operating system 1808, the agent 2014 may be provided for the networking device 1804, etc.), providing those agents using an agent provisioning subsystem coupled to that LCS component (e.g., the agent 2006 may be provided for the BMS 1801 using the operating system 1808, the agent 2008 may be provided for the processing device 1802 using the operating system 1808, the agent 2010 may be provided for the core 1802a using the operating system 1808, the agent 2012 may be provided for the core 1802b using the operating system 1808, the agent 2016 may be provided for the storage device 1806 using a storage controller, etc.), and/or providing those agents using other techniques that would be apparent to one of skill in the art in possession of the present disclosure.

Furthermore, the provisioning of an agent for any LCS component at block 1706 may include using the LCS component policy graph model nodes connected to the LCS component graph model node that identifies that LCS component to identify the policies for that LCS component to that agent. For example, the LCS policy nodes 1902a-1902n connected to the LCS node 1902 in the LCS component policy graph model 1901 may be used to identify their corresponding policies for the LCS 1810 to the agent 2002, the microvisor subsystem policy nodes 1904a-1904n connected to the microvisor subsystem node 1904 in the LCS component policy graph model 1901 may be used to identify their corresponding policies for the microvisor subsystem 1808a to the agent 2002, the operating system policy nodes 1906a-1906n connected to the operating system node 1906 in the LCS component policy graph model 1901 may be used to identify their corresponding policies for the operating system 1808 to the agent 2004, the BMS policy nodes 1908a-1908n connected to the BMS node 1908 in the LCS component policy graph model 1901 may be used to identify their corresponding policies for the BMS 1801 to agent 2006, the processing device policy nodes 1910a-1910n connected to the processing device node 1910 in the LCS component policy graph model 1901 may be used to identify their corresponding policies for the processing device 1802 to agent 2008, the core policy nodes 1912a-1912n connected to the core node 1912 in the LCS component policy graph model 1901 may be used to identify their corresponding policies for the core 1802a to the agent 2010, the core policy nodes 1914a-1914n connected to the core node 1914 in the LCS component policy graph model 1901 may be used to identify their corresponding policies for the core 1802b to the agent 2012, the networking device policy nodes 1916a-1916n connected to the networking device node 1916 in the LCS component policy graph model 1901 may be used to identify their corresponding policies for the networking device 1804 to the agent 2014, and the storage device policy nodes 1918a-1918n connected to the storage device node 1918 in the LCS component policy graph model 1901 may be used to identify their corresponding policies for the storage device 1806 to the agent 2016.

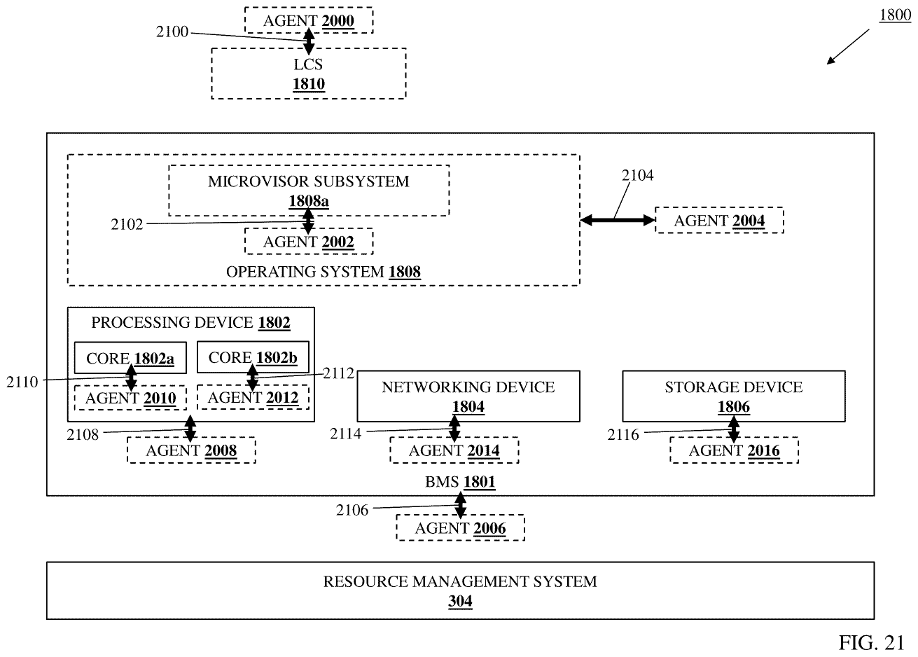

Following the provisioning of the agents at block 1706, each of those agents may monitor policy compliance by the LCS component for which they were provided. For example, with reference to FIG. 21, the agent 2000 may perform LCS monitoring operations 2100 for the LCS 1810 to monitor the operation of the LCS 1810, the agent 2002 may perform microvisor monitoring operations 2102 for the microvisor subsystem 1808a to monitor the operation of the microvisor subsystem 1808a in providing the LCS 1810, the agent 2004 may perform operating system monitoring operations 2104 for the operating system 1808 to monitor the operation of the operating system 1808 in providing the LCS 1810, the agent 2006 may perform BMS monitoring operations 2106 for the BMS 1801 to monitor the operation of the BMS 1801 in providing the LCS 1810, the agent 2008 may perform processing device monitoring operations 2108 for the processing device 1802 to monitor the operation of the processing device 1802 in providing the LCS 1810, the agent 2010 may perform core monitoring operations 2110 for the core 1802a to monitor the operation of the core 1802a in providing the LCS 1810, the agent 2012 may perform core monitoring operations 2112 for the core 1802b to monitor the operation of the core 1802b in providing the LCS 1810, the agent 2014 may perform networking monitoring operations 2114 for the networking device 1804 to monitor the operation of the networking device 1804 in providing the LCS 1810, and the agent 2016 may perform storage monitoring operations 2116 for the storage device 1806 to monitor the operation of the storage device 1806 in providing the LCS 1810.

The method 1700 then proceeds to decision block 1708 where the method 1700 proceeds depending on whether LCS component policies are violated. As will be appreciated by one of skill in the art in possession of the present disclosure, at block 1708, the monitoring operations performed by any of the agents provided at block 1706 may include determinations of whether the operation of their LCS component violates any of the policies identified the LCS component policy graph nodes connected to the LCS component graph node that identifies that LCS component. If, at decision block 1708, none of the operations of any of the LCS components monitored by their respective agents violate the LCS component policies for each of those LCS components (as verified by each agent by comparing data representing those operations against the policies identified by the LCS component policy graph model nodes connected to the LCS component graph model node in the LCS component policy graph model 1901 that identifies that LCS component), the method 1700 returns to decision block 1708. As such, the method 1700 may loop such that each agent continues to monitor the operation of its LCS component until that operation violates a policy identified by the LCS component policy graph model nodes connected to the LCS component graph model node in the LCS component policy graph model 1901 that identifies that LCS component.

If, at decision block 1708, any LCS component policies are violated, the method 1700 proceeds to block 1710 where an agent and/or the resource management system perform policy remediation operations. In an embodiment, at block 1710, any of the agents may determine that data representing the operations of its LCS component violates a policy identified by the LCS component policy graph model nodes connected to the LCS component graph model node in the LCS component policy graph model 1901 that identifies that LCS component and, in response, may operate by itself and/or with the resource management system 304 to perform a policy remediation operation(s).

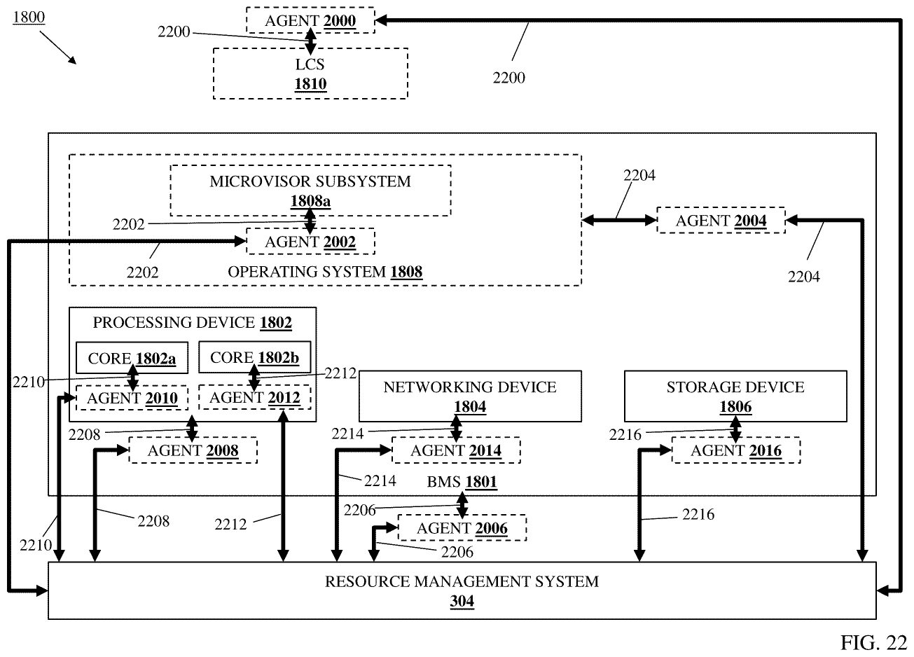

For example, with reference to FIG. 22, in response to determining that the operation of the LCS 1810 has violated any policy identified by the LCS policy nodes 1902a-1902n connected to the LCS node 1902 in the LCS component policy graph model 1901 that identifies the LCS 1810, the agent 2000 and/or the resource management system 304 may perform policy remediation operation(s) 2200 for the LCS 1810 that may include shutting down the LCS 1810, throttling access to a capability of the LCS 1810, preventing access to a resource of the LCS 1810, restarting the LCS 1810, and/or other policy remediation operations that one of skill in the art in possession of the present disclosure would appreciate may be performed for an LCS.

Similarly, with reference to FIG. 22, in response to determining that the operation of the microvisor subsystem 1808a has violated any policy identified by the microvisor subsystem policy nodes 1904a-1904n connected to the microvisor subsystem node 1904 in the LCS component policy graph model 1901 that identifies the microvisor subsystem 1808a, the agent 2002 and/or the resource management system 304 may perform policy remediation operation(s) 2202 for the microvisor subsystem 1808a that may include reinstalling the microvisor subsystem 1808a, rebuilding the microvisor subsystem 1808a, repaving the microvisor subsystem 1808a, restarting the microvisor subsystem 1808a, shutting down the microvisor subsystem 1808a, limiting the number of users and/or LCSs provided using the microvisor subsystem 1808a, updating the microvisor subsystem 1808a, upgrading the microvisor subsystem 1808a, and/or other policy remediation operations that one of skill in the art in possession of the present disclosure would appreciate may be performed for a microvisor.

Similarly, with reference to FIG. 22, in response to determining that the operation of the operating system 1808 has violated any policy identified by the operating system policy nodes 1906a-1906n connected to the operating system node 1906 in the LCS component policy graph model 1901 that identifies the operating system 1808, the agent 2004 and/or the resource management system 304 may perform policy remediation operation(s) 2204 for the operating system 1808 that may include reinstalling the operating system 1808, rebuilding the operating system 1808, repaving the operating system 1808, restarting the operating system 1808, shutting down the operating system 1808, limiting the number of users and/or LCSs provided using the operating system 1808, updating the operating system 1808, upgrading the operating system 1808, and/or other policy remediation operations that one of skill in the art in possession of the present disclosure would appreciate may be performed for an operating system.

Similarly, with reference to FIG. 22, in response to determining that the operation of the BMS 1801 has violated any policy identified by the BMS policy nodes 1908a-1908n connected to the BMS node 1908 in the LCS component policy graph model 1901 that identifies the BMS 1801, the agent 2006 and/or the resource management system 304 may perform policy remediation operation(s) 2206 for the BMS 1801 that may include evicting a user or LCS from using a resource device in the BMS 1801, constraining the performance of resources in the BMS 1801 available to an LCS, resetting or otherwise reinitializing the BMS 1801, identifying resource devices that are not currently being used to replace resource devices in the BMS 1801 that are currently being used, and/or any other policy remediation operations that one of skill in the art in possession of the present disclosure would appreciate may be performed for a BMS.

Similarly, with reference to FIG. 22, in response to determining that the operation of the processing device 1802 has violated any policy identified by the processing device policy nodes 1910a-1910n connected to the processing device node 1910 in the LCS component policy graph model 1901 that identifies the processing device 1802, the agent 2008 and/or the resource management system 304 may perform policy remediation operation(s) 2208 for the processing device 1802 that may include moving a user or LCS to a different processing device, isolating a processing load to a set of cores in the processing device 1802, throttling the performance of the processing device 1802 or an I/O device connected to the processing device 1802, moving one or more workloads away from the processing device 1802, stopping the processing device 1802, and/or any other policy remediation operations that one of skill in the art in possession of the present disclosure would appreciate may be performed for a processing device.

Similarly, with reference to FIG. 22, in response to determining that the operation of the core 1802a has violated any policy identified by the core policy nodes 1912a-1912n connected to the core node 1912 in the LCS component policy graph model 1901 that identifies the core 1802a, the agent 2010 and/or the resource management system 304 may perform policy remediation operation(s) 2210 for the core 1802a that may include evicting a user or LCS from the core 1802a, isolating a workload to particular cores and away from other workloads, throttling the core 1802a, stopping the core 1802a from operating with a particular workload, and/or any other policy remediation operations that one of skill in the art in possession of the present disclosure would appreciate may be performed for a core.

Similarly, with reference to FIG. 22, in response to determining that the operation of the core 1802b has violated any policy identified by the core policy nodes 1914a-1914n connected to the core node 1914 in the LCS component policy graph model 1901 that identifies the core 1802b, the agent 2012 and/or the resource management system 304 may perform policy remediation operation(s) 2212 for the core 1802b that may include evicting a user or LCS from the core 1802b, isolating a workload to particular cores and away from other workloads, throttling the core 1802b, stopping the core 1802b from operating with a particular workload, and/or any other policy remediation operations that one of skill in the art in possession of the present disclosure would appreciate may be performed for a core.

Similarly, with reference to FIG. 22, in response to determining that the operation of the networking device 1804 has violated any policy identified by the networking device policy nodes 1916a-1916n connected to the networking device node 1916 in the LCS component policy graph model 1901 that identifies the networking device 1804, the agent 2014 and/or the resource management system 304 may perform policy remediation operation(s) 2214 for the networking device 1804 that may include scanning and isolating for compromised network devices, providing access restrictions to users to specific resources on a network, optimizing network device configuration settings for users in the event of policy violations, performing manual/automated compliance remediations by means of security patches, performing firmware updates, managing VLANs, and/or other policy remediation operations that one of skill in the art in possession of the present disclosure would appreciate may be performed for a networking device.

Similarly, with reference to FIG. 22, in response to determining that the operation of the storage device 1806 has violated any policy identified by the storage device policy nodes 1918a-1918n connected to the storage device node 1918 in the LCS component policy graph model 1901 that identifies the storage device 1806, the agent 2016 and/or the resource management system 304 may perform policy remediation operation(s) 2216 for the storage device 1806 that may include modifying storage configuration settings such as queue depths to optimize user-specific performance, updating components for faulty storage devices, upgrading firmware used by LCSs, load balancing IO requests across multiple storage devices, remediating any storage data compliance issues by conforming to standardized methods across storage devices, enriching data classification or cleansing/deduplication policies, and/or other policy remediation operations that one of skill in the art in possession of the present disclosure would appreciate may be performed for a storage device.

As will be appreciated by one of skill in the art in possession of the present disclosure, the LCS component policy graph model 1901 and agents described above enable granular control and management of the LCS components for the LCS 1810 by identifying those LCS components individually, tracking their state and operation, and enabling the enforcement of policies for those LCS components, thereby enhancing the overall trust and security posture of the LCS provisioning subsystem. Furthermore, policy stacks provided for LCSs may restrict access to resource devices to particular LCSs, including limiting access or editing rights to sensitive resource devices/LCS components to improve the security of the LCS provisioning subsystem and the LCSs it provides.

Thus, systems and methods have been described that provide agents to monitor each of a plurality of LCS components of an LCS to determine whether policies for each of those LCS components are violated. For example, the graph-modeling-based LCS component policy monitoring system of the present disclosure may include resource devices coupled to a resource management system that uses the resource devices to compose an LCS that includes LCS components. The resource management system then generates an LCS component monitoring graph model that includes respective LCS component graph model nodes identifying each LCS component, and a respective LCS component policy graph model node connected to each respective LCS component graph model node via a respective graph model edge and identifying a policy for the LCS component identified by its connected respective LCS component graph model node. The resource management system then provides, for each of the LCS components, a respective agent that monitors that LCS component and determine whether the policy identified by the LCS component policy graph model node connected to the LCS component graph model node identifying that LCS component in the LCS component monitoring graph model is violated.

As such, an LCS may be provided with a policy stack including policies for layered physical and logical LCS components that are discretely defined for that layer and that may not correlate with policies outside of that layer. Furthermore, each LCS component may be deployed with a configuration state and authorization attributes that may dynamically change while being monitored by the agent provided for that LCS component, and the resource management system may leverage LCS-component correlation across agents to achieve secure, desired outcome-based decisions for the overall policy stack of the LCS. One of skill in the art in possession of the present disclosure will appreciate how the systems and methods of the present disclosure allow the dynamic nesting and/or interleaving of end-to-end policies for a LCS in its policy stack that enable coherent decisions about LCS component operations irrespective of its composition.

Finally, one of skill in the art in possession of the present disclosure will appreciate how the graph-modeling-based LCS component policy monitoring system allows for the dynamic visualization of the overall policy hierarchy for LCSs provided by the LCS provisioning subsystem, and may be used when resource devices are added to the LCS provisioning subsystem to determine how LCS provisioning should proceed. The use of the LCS component policy graph models as described above to derive multi-layer policy nesting for LCSs enabled context-agnostic decision making for the various resource devices in the LCS provisioning subsystem and the LCS components they provide (or are used to provide), ensuring the authorized operation of those resource devices and LCS components in order to provide a robust security posture for the LCS provisioning subsystem, and allowing policy optimizations to be determined and recommended to dynamically adjust the operation of the LCS provisioning subsystem based on historical policy decisions and outcomes.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A graph-modeling-based Logically Composed System (LCS) component policy monitoring system, comprising:
a plurality of resource devices; and
a resource management system that is coupled to the plurality of resource devices and that is configured to:
compose, using the plurality of resource devices, a Logically Composed System (LCS) that includes a plurality of LCS components;
generate an LCS component monitoring graph model that includes:
respective LCS component graph model nodes identifying each of the plurality of LCS components; and
a respective LCS component policy graph model node that is connected to each respective LCS component graph model node via respective graph model edge and that identifies a policy for the LCS component identified by its connected respective LCS component graph model node;
provide, for each of the plurality of LCS components, a respective agent that is configured to monitor that LCS component and determine whether the policy identified by the LCS component policy graph model node connected to the LCS component graph model node identifying that LCS component in the LCS component monitoring graph model is violated; and
perform, in response to of any of the respective agents provided for any of the plurality of LCS components determining that the policy for that LCS component is violated, at least one policy remediation operation.

2. The system of claim 1, wherein the plurality of resource devices include a processing device, a plurality of cores in the processing device, a networking device, a storage device, and a Bare Metal Server (BMS), and wherein the LCS components include the processing device, the plurality of cores in the processing device, the networking device, the storage device, and the Bare Metal Server (BMS).

3. The system of claim 2, wherein the plurality of LCS components include an operating system, a microvisor subsystem provided by the operating system, and the LCS.

4. The system of claim 1, wherein the respective agent provided for each of the plurality of LCS components is configured to request the resource management system to perform the at least one policy remediation operation.

5. The system of claim 1, wherein the policy remediation operation includes updating the policy for the LCS component that was violated.

6. The system of claim 1, wherein the policy remediation operation includes preventing the utilization of the LCS component whose policy was violated.

7. An Information Handling System (IHS), comprising:
a processing system; and
a memory system that is coupled to the processing system and that includes instructions that, when executed by the processing system, cause the processing system to provide a resource management engine that is configured to:
compose, using a plurality of resource devices that are coupled to the processing system, a Logically Composed System (LCS) that includes a plurality of LCS components;
generate an LCS component monitoring graph model that includes:
respective LCS component graph model nodes identifying each of the plurality of LCS components; and
a respective LCS component policy graph model node that is connected to each respective LCS component graph model node via respective graph model edge and that identifies a policy for the LCS component identified by its connected respective LCS component graph model node;
provide, for each of the plurality of LCS components, a respective agent that is configured to monitor that LCS component and determine whether the policy identified by the LCS component policy graph model node connected to the LCS component graph model node identifying that LCS component in the LCS component monitoring graph model is violated; and
perform, in response to of any of the respective agents provided for any of the plurality of LCS components determining that the policy for that LCS component is violated, at least one policy remediation operation.

8. The IHS of claim 7, wherein the plurality of resource devices include a processing device, a plurality of cores in the processing device, a networking device, a storage device, and a Bare Metal Server (BMS), and wherein the LCS components include the processing device, the plurality of cores in the processing device, the networking device, the storage device, and the Bare Metal Server (BMS).

9. The IHS of claim 8, wherein the plurality of LCS components include an operating system, a microvisor subsystem provided by the operating system, and the LCS.

10. The IHS of claim 7, wherein the respective agent provided for each of the plurality of LCS components is configured to request the resource management system to perform the at least one policy remediation operation.

11. The IHS of claim 7, wherein the policy remediation operation includes updating the policy for the LCS component that was violated.

12. The IHS of claim 7, wherein the policy remediation operation includes preventing the utilization by the LCS of the LCS component whose policy was violated.

13. The IHS of claim 7, wherein the policy remediation operation includes only allowing the utilization by the LCS of the LCS component whose policy was violated.

14. A method for monitoring policies for Logically Composed System (LCS) components using graph modeling, comprising:
composing, by a resource management system using a plurality of resource devices, a Logically Composed System (LCS) that includes a plurality of LCS components;
generating, by the resource management system, an LCS component monitoring graph model that includes:
respective LCS component graph model nodes identifying each of the plurality of LCS components; and
a respective LCS component policy graph model node that is connected to each respective LCS component graph model node via respective graph model edge and that identifies a policy for the LCS component identified by its connected respective LCS component graph model node;
providing, by the resource management system for each of the plurality of LCS components, a respective agent that monitors that LCS component and determines whether the policy identified by the LCS component policy graph model node connected to the LCS component graph model node identifying that LCS component in the LCS component monitoring graph model is violated; and
performing, by the resource management system in response to of any of the respective agents provided for any of the plurality of LCS components determining that the policy for that LCS component is violated, at least one policy remediation operation.

15. The method of claim 14, wherein the plurality of resource devices include a processing device, a plurality of cores in the processing device, a networking device, a storage device, and a Bare Metal Server (BMS), and wherein the LCS components include the processing device, the plurality of cores in the processing device, the networking device, the storage device, and the Bare Metal Server (BMS).

16. The method of claim 15, wherein the plurality of LCS components include an operating system, a microvisor subsystem provided by the operating system, and the LCS.

17. The method of claim 14, wherein the respective agent provided for each of the plurality of LCS components requests the resource management system to perform the at least one policy remediation operation.

18. The method of claim 14, wherein the policy remediation operation includes updating the policy for the LCS component that was violated.

19. The method of claim 14, wherein the policy remediation operation includes preventing the utilization by the LCS of the LCS component whose policy was violated.

20. The method of claim 14, wherein the policy remediation operation includes only allowing the utilization by the LCS of the LCS component whose policy was violated.
